(19) United States
(12) Patent Application Publication
(10) Pub. No.: US 2018/0063435 A1
(43) Pub. Date: Mar. 1, 2018

(54) METHOD FOR ESTIMATING ILLUMINANCE AND AN ELECTRONIC DEVICE THEREOF

(71) Applicant: SAMSUNG ELECTRONICS CO., LTD., Suwon-si (KR)

(72) Inventors: Jeong-Ho CHO, Hwaseong-si (KR); Hee-Woong YOON, Seoul (KR); Il-Young KIM, Suwon-si (KR); Jeongyeol LEE, Suwon-si (KR); Hyungjin RHO, Yongin-si (KR); Song Hee JUNG, Suwon-si (KR); Oheon KWON, Yongin-si (KR); Heejun CHOI, Hongseong-gun (KR); Jeong-Min PARK, Hwaseong-si (KR); Kihuk LEE, Suwon-si (KR)

(21) Appl. No.: 15/638,775

(22) Filed: Jun. 30, 2017

(30) Foreign Application Priority Data
Aug. 29, 2016 (KR) 10-2016-0110238

(51) Int. Cl. H04N 5/232; H04N 5/235

(52) U.S. Cl. CPC H04N 5/23248; H04N 5/23212; H04N 5/23274; H04N 5/2351; H04N 5/23219

(57) ABSTRACT

A method and an electronic device for measuring illuminance are provided. An operating method of the electronic device includes identifying time intervals when a display of the electronic device operates in a deactivated state, and determining illuminance using at least one sensing value measured through an illuminance sensor during the identified time intervals. The illuminance sensor may be disposed under the display.

### CROSS-REFERENCE TO RELATED APPLICATION

The present disclosure is based on and claims priority under 35 U.S.C. § 119 to a Korean patent application filed in the Korean Intellectual Property Office on Aug. 29, 2016, and assigned Serial No. 10-2016-0110238, the disclosure of which is incorporated by reference herein in its entirety.

### TECHNICAL FIELD

The present disclosure relates generally to illuminance measurement in an electronic device.

### BACKGROUND

As portable electronic devices such as smart phones exhibit high performance, various services are provided through electronic devices. For example, services expand from basic services such as call, text transmission to more complicated services such as game, messenger, document editing, and image/video play and editing.

As the electronic device provides various services, various functions beside simple data input/output and processing are required. For example, a sensing function using various sensors can be required. For example, a sensor using a light can be used. For example, the sensor using the light can include a camera, an Ultra Violet (UV) sensor, an iris sensor, a spectral sensor, a proximity/gesture sensor using Infra-Red (IR), a Red Green Blue (RGB) sensor, and an illuminance sensor.

The illuminance sensor can be used to measure illuminance of an environment around the electronic device. However, depending on a position of the installed illuminance sensor, not only the light outside the electronic device but also the light emitted by the electronic device can affect the measurement of the illuminance sensor.

### SUMMARY OF THE DISCLOSURE

To address the above-discussed deficiencies, it is an example aspect of the present disclosure to provide a method and an electronic device for measuring illuminance.

Another example aspect of the present disclosure is to provide a method and an electronic device for measuring illuminance using an illuminance sensor disposed on a back side of a display.

Yet another example aspect of the present disclosure is to provide a method and an electronic device for measuring illuminance by considering (taking into account) a light emitted from a display.

Still another example aspect of the present disclosure is to provide a method and an electronic device for measuring illuminance in a non-emitting duration of a display.

A further example aspect of the present disclosure is to provide a method and an electronic device for integrating sensing values measured in non-emitting durations of a display.

A further example aspect of the present disclosure is to provide a method and an electronic device for measuring illuminance by considering afterimage of a display.

A further example aspect of the present disclosure is to provide a method and an electronic device for illuminance at a low light level.

A further example aspect of the present disclosure is to provide a method and an electronic device for compensating for illuminance measured under sidelight.

According to an example aspect of the present disclosure, a method of an electronic device includes identifying time intervals when a display of the electronic device operates in a deactivated state, and determining illuminance using at least one sensing value measured through an illuminance sensor during the identified time intervals, wherein the illuminance sensor is disposed under the display.

According to another example aspect of the present disclosure, an electronic device includes a display configured to display a screen, an illuminance sensor disposed under the display, and a processor configured to control the display and the illuminance sensor. The processor is configured to identify time intervals when the display of the electronic device operates in a deactivated state, and to determine illuminance using at least one sensing value measured through the illuminance sensor during the identified time intervals.

Other aspects, advantages, and salient features of the disclosure will become apparent to those skilled in the art from the following detailed description, which, taken in conjunction with the annexed drawings, discloses example embodiments of the disclosure.

### BRIEF DESCRIPTION OF THE DRAWINGS

The above and other aspects, features, and attendant advantages of the present disclosure will be more apparent and readily appreciated from the following detailed description, taken in conjunction with the accompanying drawings, in which like reference numerals refer to like elements, and wherein:

FIG. 1 is a diagram illustrating an example electronic device in a network according to various example embodiments of the present disclosure;

FIG. 2 is a block diagram illustrating an example electronic device according to various example embodiments of the present disclosure;

FIG. 3 is a block diagram illustrating an example program module according to various example embodiments of the present disclosure;

FIGS. 4A, 4B, 4C and 4D are diagrams illustrating an example illuminance sensor disposed in an electronic device according to various example embodiments of the present disclosure;

FIG. 5 is a block diagram illustrating an example electronic device according to various example embodiments of the present disclosure;

FIGS. 6A and 6B are diagrams illustrating an example structure and measurement results of an illuminance sensor of an electronic device according to various example embodiments of the present disclosure;

FIG. 7 is a flowchart illustrating an example method for measuring illuminance in an electronic device according to various example embodiments of the present disclosure;

FIG. 8 is a diagram illustrating an example emitting period of a display in an electronic device according to various example embodiments of the present disclosure;

FIGS. 9A and 9B are sequence diagrams illustrating example signal exchange and control timing for synchronization in response to emission period change of a display in an electronic device according to various example embodiments of the present disclosure;

FIG. 10 is a flowchart illustrating an example method for measuring a sensing value in an electronic device according to various embodiments of the present disclosure;

FIG. 11 is a diagram illustrating example sensing timing of an illuminance sensor in an electronic device according to various example embodiments of the present disclosure;

FIG. 12 is a flowchart illustrating an example method for measuring a sensing value in an electronic device according to various example embodiments of the present disclosure;

FIG. 13 is a diagram illustrating example sensing timing of an illuminance sensor in an electronic device according to various example embodiments of the present disclosure;

FIG. 14 is a flowchart illustrating an example method for measuring a sensing value in an electronic device according to various example embodiments of the present disclosure;

FIG. 15 is a diagram illustrating example sensing timing of an illuminance sensor in an electronic device according to various example embodiments of the present disclosure;

FIG. 16 is a flowchart illustrating an example method for determining illuminance based on a sensing value in an electronic device according to various example embodiments of the present disclosure;

FIG. 17 is a diagram illustrating an example camera sensor for measuring illuminance in an electronic device according to various example embodiments of the present disclosure;

FIG. 18 is a flowchart illustrating an example method for compensating for a sensing value with a sidelight in an electronic device according to various example embodiments of the present disclosure;

FIGS. 19A and 19B are diagrams illustrating example relative degrees from a light source in an electronic device according to various example embodiments of the present disclosure;

FIGS. 20A and 20B are diagrams illustrating example illuminance value changes before and after compensation in an electronic device according to various example embodiments of the present disclosure;

FIG. 21 is a diagram illustrating an example illuminance sensor structure in an electronic device according to various example embodiments of the present disclosure;

FIG. 22 is a flowchart illustrating an example method for measuring illuminance by considering a display color in an electronic device according to various example embodiments of the present disclosure;

FIG. 23 is a flowchart illustrating an example method for measuring illuminance by considering a folding state of a display in an electronic device according to various example embodiments of the present disclosure;

FIG. 24 is a flowchart illustrating an example method for determining a waiting time by considering afterimage of a display in an electronic device according to various example embodiments of the present disclosure; and

FIG. 25 is a diagram illustrating example illuminance measurement results during waiting time determination in an electronic device according to various example embodiments of the present disclosure.

Throughout the drawings, like reference numerals will be understood to refer to like parts, components and structures.

### DETAILED DESCRIPTION

Various example embodiments of the present disclosure are described in greater detail with reference to the accompanying drawings. It should be understood that it is not intended to limit various embodiments and terms of the present disclosure to a particular form but, on the contrary, the intention is to cover various modifications, equivalents, and/or alternatives of the embodiments of the present disclosure. The same or similar components may be designated by the same or similar reference numerals although they are illustrated in different drawings. It is to be understood that the singular forms include plural referents unless the context clearly dictates otherwise. In the present disclosure, an expression such as “A or B,” “at least one of A and B,” or “one or more of A and B” may include all possible combinations of the listed items. Expressions such as “first,” “second,” “primarily,” or “secondary,” as used herein, may represent various elements regardless of order and/or importance and do not limit corresponding elements. The expressions may be used for distinguishing one element from another element. When it is described that an element (such as a first element) is “(operatively or communicatively) coupled” to or “connected” to another element (such as a second element), the element can be directly connected to the other element or can be connected through another element (such as a third element).

An expression “configured to (or set)” used in the present disclosure may be used interchangeably with, for example, “suitable for,” “having the capacity to,” “designed to,” “adapted to,” “made to,” or “capable of” by hardware or by software according to a situation. Alternatively, in some situations, the expression “apparatus configured to” may refer, for example, to a situation in which the apparatus “can” operate together with another apparatus or component. For example, a phrase “a processor configured (or set) to perform A, B, and C” may refer to a dedicated processor, a generic-purpose processor (such as a Central Processing Unit (CPU) or an application processor) that can perform a corresponding operation by executing at least one software program stored at an exclusive processor (such as an embedded processor) for performing a corresponding operation or at a memory device, or the like, but is not limited thereto.

An electronic device according to various example embodiments of the present disclosure, may be, for example, at least one of a smart phone, a tablet Personal Computer (PC), a mobile phone, a video phone, an e-book reader, a desktop PC, a laptop PC, a netbook computer, a workstation, a server, a Personal Digital Assistant (PDA), a Portable Multimedia Player (PMP), an MPEG 3 (MP3) player, a medical equipment, a camera, and a wearable device, or the like, but is not limited thereto. The wearable device can include at least one of an accessory type (e.g., a watch, a ring, a bracelet, an ankle bracelet, a necklace, glasses, a contact lens, or a Head-Mounted-Device (HMD)), a fabric or clothing embedded type (e.g., electronic garments), a body attachable type (e.g., a skin pad or a tattoo), and an implantable circuit, or the like, but is not limited thereto. The electronic device can include as at least one of, for example, a television, a Digital Versatile Disc (DVD) player, an audio device, a refrigerator, an air-conditioner, a cleaner, an oven, a microwave oven, a washing machine, an air cleaner, a set-top box, a home automation control panel, a security control panel, a media box (e.g., Samsung HomeSync™, Apple TV™, or Google TV™), a game console (e.g., Xbox™, PlayStation™), an electronic dictionary, an electronic key, a camcorder, and an electronic frame, or the like, but is not limited thereto.

In another example embodiment, the electronic device can include as at least one of various medical devices (such as, various portable medical measuring devices (a blood sugar measuring device, a heartbeat measuring device, a blood pressure measuring device, or a body temperature measuring device), a Magnetic Resonance Angiography (MRA) device, a Magnetic Resonance Imaging (MRI) device, a Computed Tomography (CT) device, a scanning machine, and an ultrasonic wave device), a navigation device, a Global Navigation Satellite System (GNSS), an Event Data Recorder (EDR), a Flight Data Recorder (FDR), a vehicle infotainment device, electronic equipment for ship (such as, a navigation device for ship and gyro compass), avionics, a security device, a head unit for a vehicle, an industrial or home robot, a drone, an Automated Teller Machine (ATM) of a financial institution, a Point Of Sales (POS) device of a store, and an Internet of Things (IoT) device (e.g., a light bulb, various sensors, a sprinkler device, a fire alarm, a thermostat, a street light, a toaster, sports equipment, a hot water tank, a heater, and a boiler), or the like, but is not limited thereto. According to an example embodiment, the electronic device can include at least one of a portion of furniture, building/construction or vehicle, an electronic board, an electronic signature receiving device, a projector, and various measuring devices (e.g., water supply, electricity, gas, or electric wave measuring device), or the like, but is not limited thereto. An electronic device, according to various embodiments, can be a flexible electronic device or a combination of two or more of the foregoing various devices. An electronic device, according to an embodiment of the present disclosure, is not limited to the foregoing devices. The term “user”, as used herein, can refer to a person using an electronic device or a device using an electronic device (e.g., an artificial intelligence electronic device).

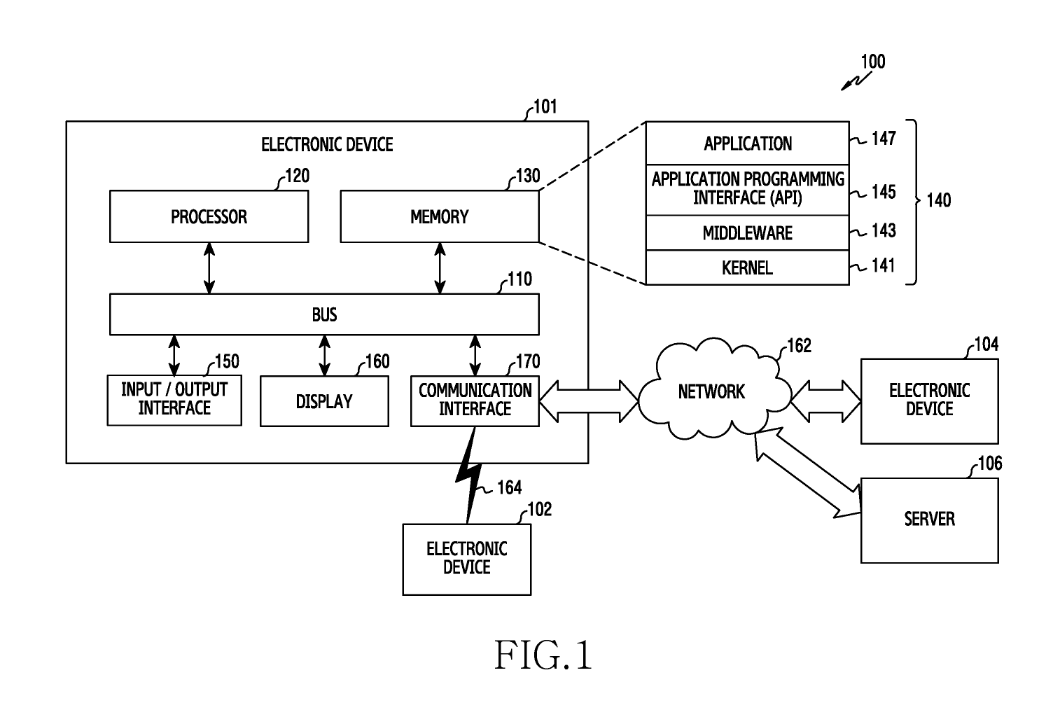

Referring initially to FIG. 1, an electronic device 101 resides in a network environment 100. The electronic device 101 can include a bus 110, a processor (e.g., including processing circuitry) 120, a memory 130, an input/output interface (e.g., including input/output interface circuitry) 150, a display 160, and a communication interface (e.g., including communication circuitry) 170. The electronic device 101 can be provided without at least one of the components, or can include at least one additional component. The bus 110 can include a circuit for connecting the components 120 through 170 and delivering communication (e.g., control messages or data) therebetween. The processor 120 may include various processing circuitry, such as, for example, and without limitation, one or more of a dedicated processor, a CPU, an application processor, and a Communication Processor (CP). The processor 120, for example, can perform an operation or data processing with respect to control and/or communication of at least another component of the electronic device 101.

The memory 130 can include a volatile and/or nonvolatile memory. The memory 130, for example, can store commands or data associated with at least another component of the electronic device 101. According to an embodiment, the memory 130 can store software and/or a program 140. The program 140 can include, for example, a kernel 141, middleware 143, an Application Programming Interface (API) 145, and/or an application program (or “application”) 147. At least part of the kernel 141, the middleware 143, or the API 145 can be referred to as an Operating System (OS). The kernel 141 can control or manage system resources (e.g., the bus 110, the processor 120, or the memory 130) used for performing operations or functions implemented by the other programs (e.g., the middleware 143, the API 145, or the application program 147). Additionally, the kernel 141 can provide an interface for controlling or managing system resources by accessing an individual component of the electronic device 101 from the middleware 143, the API 145, or the application program 147.

The middleware 143, for example, can serve an intermediary role for exchanging data between the API 145 or the application program 147 and the kernel 141 through communication. Also, the middleware 143 can process one or more job requests received from the application program 147, based on their priority. For example, the middleware 143 can assign a priority for using a system resource (e.g., the bus 110, the processor 120, or the memory 130) of the electronic device 101 to at least one of the application programs 147, and process the one or more job requests. The API 145, as an interface through which the application 147 controls a function provided from the kernel 141 or the middleware 143, can include, for example, at least one interface or function (e.g., an instruction) for file control, window control, image processing, or character control. The input/output interface 150, for example, can deliver commands or data inputted from a user or another external device to other component(s) of the electronic device 101, or output commands or data inputted from the other component(s) of the electronic device 101 to the user or another external device.

The display 160, for example, can include a Liquid Crystal Display (LCD), a Light Emitting Diode (LED) display, an Organic Light Emitting Diode (OLED) display, a MicroElectroMechanical Systems (MEMS) display, or an electronic paper display, or the like, but is not limited thereto. The display 160, for example, can display various contents (e.g., texts, images, videos, icons, and/or symbols) to the user. The display 160 can include a touch screen, for example, and receive touch, gesture, proximity, or hovering inputs by using an electronic pen or a user's body part. The communication interface 170, for example, can set a communication between the electronic device 101 and an external device (e.g., a first external electronic device 102, a second external electronic device 104, or a server 106). For example, the communication interface 170 can communicate with the external device (e.g., the second external electronic device 104 or the server 106) over a network 162 through wireless communication or wired communication. Additionally, or alternatively, the communication interface 170 can establish a short-range wireless communication connection with an electronic device (e.g., the first external electronic device 102).

The wireless communication, for example, can include cellular communication using at least one of Long Term Evolution (LTE), LTE-Advanced (LTE-A), Code Division Multiple Access (CDMA), Wideband CDMA (WCDMA), Universal Mobile Telecommunications System (UMTS), Wireless Broadband (WiBro), or Global System for Mobile Communications (GSM). The wireless communication can include, for example, at least one of Wireless Fidelity (WiFi), Bluetooth, Bluetooth Low Energy (BLE), Zigbee, Near Field Communication (NFC), magnetic secure transmission, Radio Frequency (RF), and Body Area Network (BAN). The wireless communication can include GNSS. The GNSS can include, for example, Global Positioning System (GPS), Global Navigation Satellite System (GLONASS), Beidou navigation satellite system (Beidou), or Galileo (the European global satellite-based navigation system). Hereafter, the GPS can be interchangeably used with the GNSS. The wired communication, for example, can include at least one of Universal Serial Bus (USB), High Definition Multimedia Interface (HDMI), Recommended Standard 232 (RS-232), power line communications, and Plain Old Telephone Service (POTS). The network 162 can include a telecommunications network, for example, at least one of computer network (e.g., LAN or WAN), Internet, and telephone network.

Each of the first and second external electronic devices 102 and 104 can be of the same as or of a different type from that of the electronic device 101. According to various embodiments of the present disclosure, all or part of operations executed in the electronic device 101 can be executed by another electronic device or a plurality of electronic devices (e.g., the electronic device 102 or 104, or the server 106). To perform a function or service automatically or by request, instead of performing the function or the service by the electronic device 101, the electronic device 101 can request at least part of a function relating thereto from another device (e.g., the electronic device 102 or 104, or the server 106). The other electronic device (e.g., the electronic device 102 or 104, or the server 106) can perform the requested function or an additional function and send its result to the electronic device 101. The electronic device 101 can provide the requested function or service by processing the received result. In doing so, for example, cloud computing, distributed computing, or client-server computing techniques can be used.

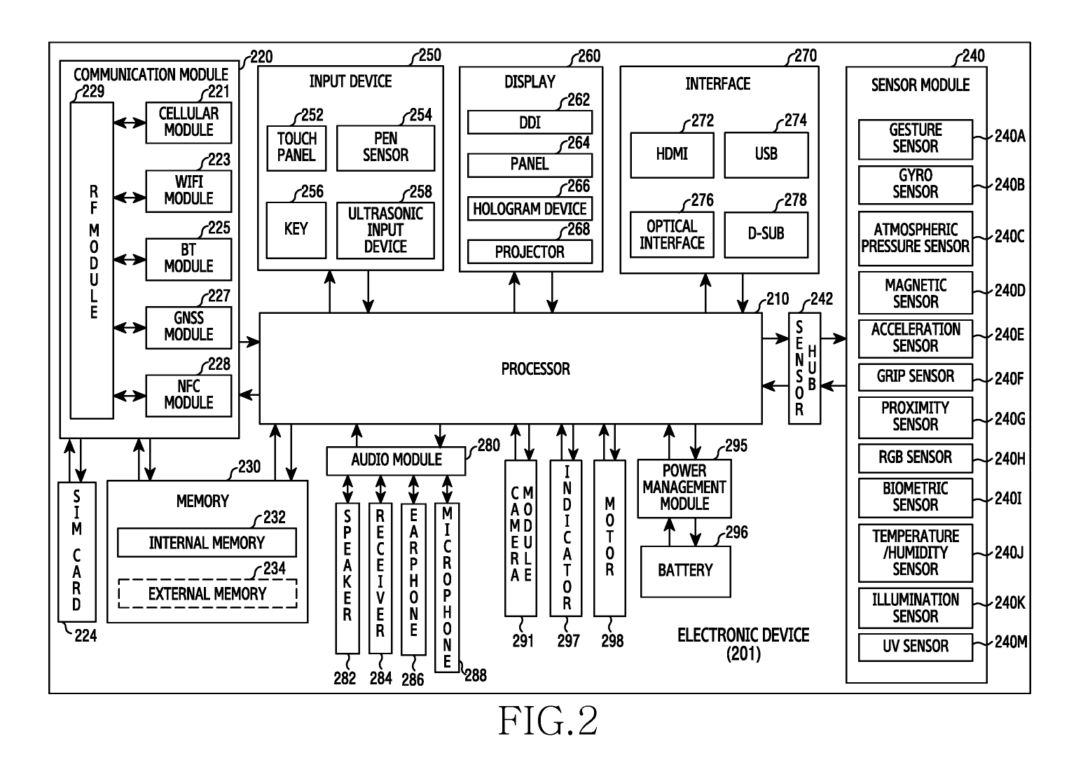

FIG. 2 is a block diagram illustrating an example electronic device 201 according to various example embodiments of the present disclosure. The electronic device 201, for example, can include all or part of the above-described electronic device 101 of FIG. 1. The electronic device 201 includes one or more processors (e.g., an AP) (e.g., including processing circuitry) 210, a communication module (e.g., including communication circuitry) 220, a Subscriber Identification Module (SIM) 224, a memory 230, a sensor module 240, a sensor hub 242, an input device (e.g., including input circuitry) 250, a display 260, an interface (e.g., including interface circuitry) 270, an audio module 280, a camera module 291, a power management module 295, a battery 296, an indicator 297, and a motor 298. The processor 210, for example, may include various processing circuitry and can control a plurality of hardware or software components connected to the processor 210, and also can perform various data processing and operations by executing an OS or an application program. The processor 210 can be implemented with a System on Chip (SoC), for example. The processor 210 can further include a Graphic Processing Unit (GPU) and/or an image signal processor. The processor 210 may include at least part (e.g., a cellular module 221) of the components shown in FIG. 2. The processor 210 can load commands or data received from at least one other component (e.g., a nonvolatile memory) into a volatile memory, process them, and store various data in the nonvolatile memory.

The communication module 220 can have the same or similar configuration to the communication interface 170 of FIG. 1. The communication module 220 may include, various communication circuitry, such as, for example, and without limitation, the cellular module 221, a WiFi module 223, a Bluetooth (BT) module 225, a GNSS module 227, an NFC module 228, and an RF module 229. The cellular module 221, for example, can provide voice call, video call, Short Message Service (SMS), or Internet service through a communication network. The cellular module 221 can identify and authenticate the electronic device 201 in a communication network by using the SIM (e.g., a SIM card) 224. The cellular module 221 can perform at least part of a function that the processor 210 provides. The cellular module 221 can further include a CP. At least some (e.g., two or more) of the cellular module 221, the WiFi module 223, the BT module 225, the GNSS module 227, and the NFC module 228 can be included in one Integrated Circuit (IC) or an IC package. The RF module 229, for example, can transmit/receive a communication signal (e.g., an RF signal). The RF module 229, for example, can include a transceiver, a Power Amp Module (PAM), a frequency filter, a Low Noise Amplifier (LNA), or an antenna. According to another embodiment, at least one of the cellular module 221, the WiFi module 223, the BT module 225, the GNSS module 227, and the NFC module 228 can transmit/receive an RF signal through an additional RF module. The SIM 224, for example, can include a card including a SIM or an embedded SIM, and also can contain unique identification information (e.g., an Integrated Circuit Card Identifier (ICCID)) or subscriber information (e.g., an International Mobile Subscriber Identity (IMSI)).

The memory 230 (e.g., the memory 130) can include at least one of an internal memory 232 and/or an external memory 234. The internal memory 232 can include at least one of, for example, a volatile memory (e.g., Dynamic RAM (DRAM), Static RAM (SRAM), or Synchronous Dynamic RAM (SDRAM)), and a non-volatile memory (e.g., One Time Programmable ROM (OTPROM), Programmable ROM (PROM), Erasable and Programmable ROM (EPROM), Electrically Erasable and Programmable ROM (EEPROM), mask ROM, flash ROM, flash memory, hard drive, and solid state drive (SSD)). The external memory 234 can include flash drive, for example, Compact Flash (CF), Secure Digital (SD), micro SD, mini SD, extreme digital (xD), Multi-Media Card (MMC), or memory stick. The external memory 234 can be functionally or physically connected to the electronic device 201 through various interfaces.

The sensor module 240 can, for example, measure physical quantities or detect an operating state of the electronic device 201, and thus convert the measured or detected information into electrical signals. The sensor module 240 can include at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (e.g., a Red, Green, Blue (RGB) sensor), a bio (e.g., biometric) sensor 240I, a temperature/humidity sensor 240J, an illuminance (e.g., illumination, light, or ambient light) sensor 240K, and an Ultra Violet (UV) sensor 240M. Additionally or alternately, the sensor module 240 can include an E-nose sensor, an Electromyography (EMG) sensor, an Electroencephalogram (EEG) sensor, an Electrocardiogram (ECG) sensor, an InfraRed (IR) sensor, an iris sensor, and/or a fingerprint sensor. The sensor module 240 can further include a control circuit for controlling at least one sensor therein. The electronic device, as part of the processor 210 or individually, can further include a processor configured to control the sensor module 240 and thus control the sensor module 240 while the processor 210 is sleeping.

The sensor hub 242 may include various receiving and transmitting circuitry and can receive measurement values of the various sensors of the sensor module 240, and send the received measurement values or a determination result based on the measurement values to the processor 210. The sensor hub 242 can receive from the processor 210 a signal for controlling the various sensors of the sensor module 240, and control the sensors based on the received signal.

The input device 250 may include various input circuitry, such as, for example, and without limitation, at least one of a touch panel 252, a (digital) pen sensor 254, a key 256, and an ultrasonic input device 258. The touch panel 252 can use at least one of, for example, capacitive, resistive, infrared, and ultrasonic methods. Additionally, the touch panel 252 can further include a control circuit. The touch panel 252 can further include a tactile layer to provide a tactile response to a user. The (digital) pen sensor 254 can include, for example, part of a touch panel or a sheet for recognition. The key 256 can include, for example, a physical button, a touch key, an optical key, or a keypad. The ultrasonic input device 258 can detect ultrasonic waves from an input means through a microphone 288 and identify data corresponding to the detected ultrasonic waves.

The display 260 (e.g., the display 160) can include at least one of a Display Driver Integrated circuit (DDI) 262, a panel 264, a hologram device 266, and a projector 268. The DDI 262 controls at least one of the panel 264, the hologram device 266, and the projector 268. For example, the DDI 262 can control luminance of the display 260 according to a control signal from the processor 210. More specifically, the DDI 262 can control the luminance by adjusting a ratio of an on duration and an off duration of the projector 268. The panel 264 can be implemented to be, for example, flexible, transparent, or wearable. The panel 264 and the touch panel 252 can be configured with one or more modules. The hologram device 266 can show three-dimensional images in the air by using the interference of light. The projector 268 can display an image by projecting light on a screen. The screen, for example, can be placed inside or outside the electronic device 201. The interface 270 may include various interface circuitry, such as, for example, and without limitation, an HDMI 272, a USB 274, an optical interface 276, or a D-subminiature (D-sub) 278. The interface 270 can be included in, for example, the communication interface 170 of FIG. 1. Additionally or alternately, the interface 270 can include a Mobile High-Definition Link (MHL) interface, a SD card/MMC interface, or an Infrared Data Association (IrDA) standard interface.

The audio module 280, for example, can convert sounds into electrical signals and convert electrical signals into sounds. At least some components of the audio module 280 can be included in, for example, the input/output interface 150 of FIG. 1. The audio module 280 can process sound information inputted or outputted through a speaker 282, a receiver 284, an earphone 286, or the microphone 288. The camera module 291, as a device for capturing still images and videos, can include one or more image sensors (e.g., a front sensor or a rear sensor), a lens, an Image Signal Processor (ISP), or a flash (e.g., an LED or a xenon lamp). The power management module 295, for example, can manage the power of the electronic device 201. According to an embodiment of the present disclosure, the power management module 295 can include a Power Management IC (PMIC), a charger IC, or a battery or fuel gauge, for example. The PMIC can have a wired and/or wireless charging method. The wireless charging method can include, for example, a magnetic resonance method, a magnetic induction method, or an electromagnetic method, and can further include an additional circuit for wireless charging, for example, a coil loop, a resonant circuit, or a rectifier circuit. The battery gauge can measure the remaining capacity of the battery 296, or a voltage, current, or temperature of the battery 296 during charging. The battery 296 can include, for example, a rechargeable battery and/or a solar battery.

The indicator 297 can display a specific state of the electronic device 201 or part thereof (e.g., the processor 210), for example, a booting state, a message state, or a charging state. The motor 298 can convert electrical signals into mechanical vibration and generate a vibration or haptic effect. The electronic device 201 can include a mobile TV supporting device (e.g., a GPU) for processing media data according to standards such as Digital Multimedia Broadcasting (DMB), Digital Video Broadcasting (DVB), or MediaFLO™. Each of the above-described components of the electronic device can be configured with at least one component and the name of a corresponding component can vary according to the kind of an electronic device. According to various embodiments of the present disclosure, an electronic device (e.g., the electronic device 201) can be configured to include at least one of the above-described components or an additional component, or to not include some of the above-described components. Additionally, some of components in an electronic device are configured as one entity, so that functions of previous corresponding components are performed identically.

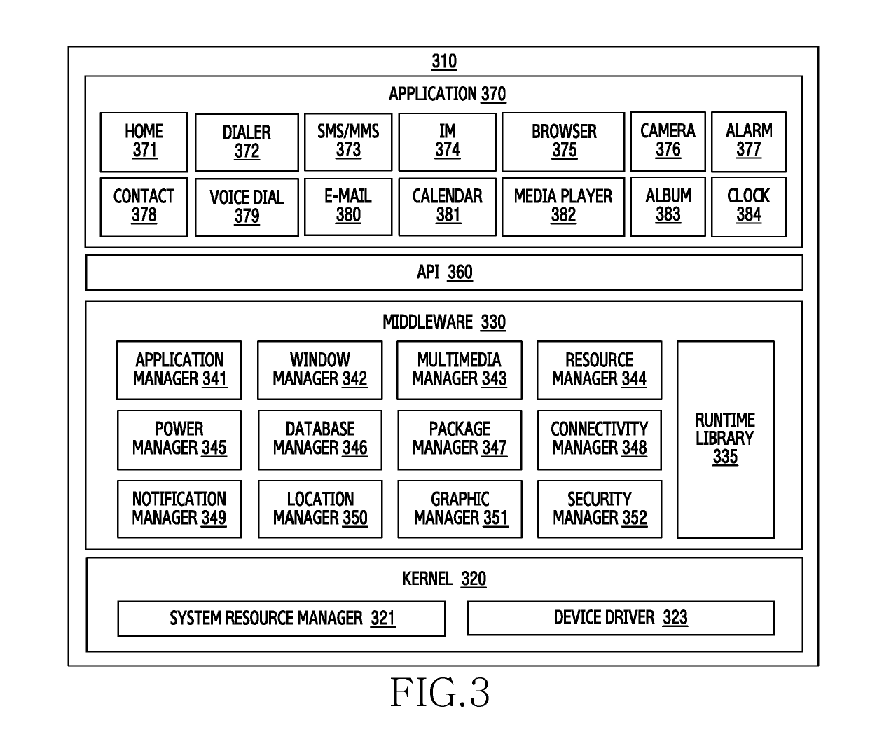

FIG. 3 is a block diagram illustrating an example program module according to various example embodiments of the present disclosure. A program module 310 (e.g., the program 140) can include an OS for controlling a resource associated with an electronic device (e.g., the electronic device 101) and/or various applications (e.g., the application program 147) running on the OS. The OS can include, for example, Android™, iOS™, Windows™, Symbian™, Tizen™, or Bada™. Referring to FIG. 3, the program module 310 can include a kernel 320 (e.g., the kernel 141), a middleware 330 (e.g., the middleware 143), an API 360 (e.g., the API 145), and/or an application 370 (e.g., the application program 147). At least part of the program module 310 can be preloaded on an electronic device or can be downloaded from an external electronic device (e.g., the electronic device 102, 104, or the server 106).

The kernel 320 includes, for example, at least one of a system resource manager 321 and/or a device driver 323. The system resource manager 321 can control, allocate, or retrieve a system resource. According to an embodiment, the system resource manager 321 can include a process management unit, a memory management unit, or a file system management unit. The device driver 323 can include, for example, a display driver, a camera driver, a Bluetooth driver, a sharing memory driver, a USB driver, a keypad driver, a WiFi driver, an audio driver, or an Inter-Process Communication (IPC) driver. The middleware 330, for example, can provide a function commonly required by the application 370, or can provide various functions to the application 370 through the API 360 in order to allow the application 370 to efficiently use a limited system resource inside the electronic device. The middleware 330 includes at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 can include, for example, a library module used by a complier to add a new function through a programming language while the application 370 is running. The runtime library 335 can manage input/output, manage memory, or arithmetic function processing. The application manager 341, for example, can manage the life cycle of the applications 370. The window manager 342 can manage a GUI resource used in a screen. The multimedia manager 343 can recognize a format for playing various media files and encode or decode a media file by using the codec in a corresponding format. The resource manager 344 can manage a source code of the application 370 or a memory space. The power manager 345 can manage the capacity or power of the battery and provide power information for an operation of the electronic device. The power manager 345 can operate together with a Basic Input/Output System (BIOS). The database manager 346 can create, search, or modify a database used in the application 370. The package manager 347 can manage installation or updating of an application distributed in a package file format.

The connectivity manger 348 can manage, for example, a wireless connection. The notification manager 349 can provide an event, such as incoming messages, appointments, and proximity alerts, to the user. The location manager 350 can manage location information of an electronic device. The graphic manager 351 can manage a graphic effect to be provided to the user or a user interface relating thereto. The security manager 352 can provide, for example, system security or user authentication. The middleware 330 can include a telephony manager for managing a voice or video call function of the electronic device, or a middleware module for combining various functions of the above-described components. The middleware 330 can provide a module specialized for each type of OS. The middleware 330 can dynamically delete part of the existing components or add new components. The API 360, as a set of API programming functions, can be provided as another configuration according to the OS. For example, Android or iSO can provide one API set for each platform, and Tizen can provide two or more API sets for each platform.

The application 370 can include at least one of a home 371, a dialer 372, an SMS/Multimedia Messaging System (MMS) 373, an Instant Message (IM) 374, a browser 375, a camera 376, an alarm 377, a contact 378, a voice dial 379, an e-mail 380, a calendar 381, a media player 382, an album 383, a clock 384. Additionally, or alternatively, the application 370 may further include, although not shown, health care (e.g., measure an exercise amount or blood sugar level), or environmental information (e.g., air pressure, humidity, or temperature information) provision application. The application 370 can include an information exchange application for supporting information exchange between the electronic device and an external electronic device. The information exchange application can include, for example, a notification relay application for relaying specific information to the external device or a device management application for managing the external electronic device. For example, the notification relay application can relay notification information from another application of the electronic device to an external electronic device, or receive and forward notification information from an external electronic device to the user. The device management application, for example, can install, delete, or update a function (e.g., turn-on/turn off of the external electronic device itself (or some components) or display brightness (or resolution) adjustment) of an external electronic device communicating with the electronic device, or an application operating in the external electronic device. The application 370 can include a specified application (e.g., a health care application of a mobile medical device) according to a property of the external electronic device. The application 370 can include an application received from an external electronic device. At least part of the program module 310 can be implemented (e.g., executed) with software, firmware, hardware (e.g., the processor 210), or a combination of at least two of them, and include a module, a program, a routine, a set of instructions, or a process for executing one or more functions.

The term “module”, as used herein, may refer, for example, to a unit including hardware, software, and firmware, or any suitable combination thereof. The term “module” can be interchangeably used with terms such as “unit”, “logic”, “logical block”, “component”, “circuit”, and the like. A module can be a minimum unit of an integral component or can be a part thereof. A module can be a minimum unit for performing one or more functions or may be a part thereof. A module can be mechanically or electrically implemented. For example, a module, according to an embodiment of the present disclosure, can include, without limitation, at least one of a dedicated processor, a CPU, an Application-Specific Integrated Circuit (ASIC) chip, a Field-Programmable Gate Arrays (FPGAs), and a programmable-logic device, which are known or will be developed and which perform certain operations. At least some parts of a device (e.g., modules or functions thereof) or a method (e.g., operations), based on embodiments of the present disclosure, can be implemented with an instruction stored in a non-transitory computer-readable storage medium (e.g., the memory 130) as a program module. When the instruction is executed by a processor (e.g., the processor 120), the processor can perform a function corresponding to the instruction. The non-transitory computer readable recording medium can include, for example, a hard disk, a floppy disc, a magnetic medium (e.g., a magnetic tape), an optical storage medium (e.g., a Compact Disc-ROM (CD-ROM) or a DVD, a magnetic-optic medium (e.g., a floptical disc)), and an internal memory. The instruction can include code created by a compiler or code executable by an interpreter. The module or program module can further include at least one or more components among the aforementioned components, or can omit some of them, or can further include additional other components. Operations performed by a module, program module, or other components of the various embodiments of the present disclosure can be executed in a sequential, parallel, repetitive, or heuristic manner. In addition, some of the operations can be executed in a different order or may be omitted, or other operations may be added.

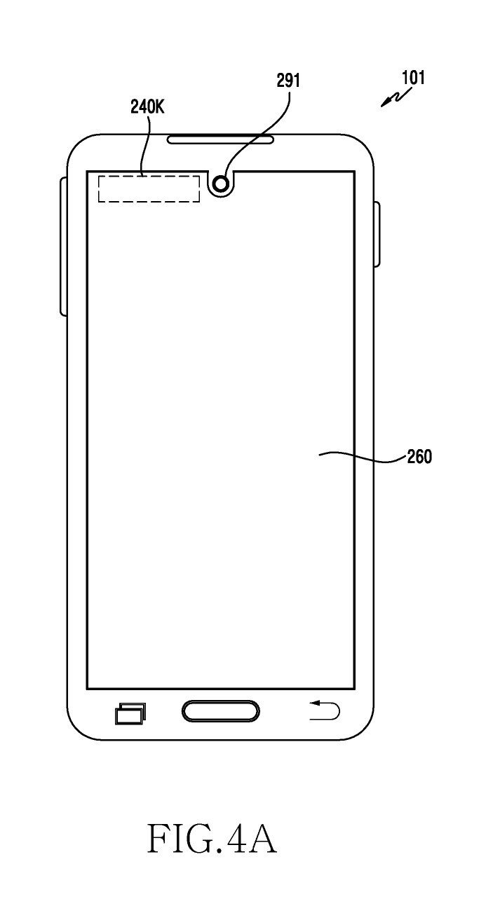

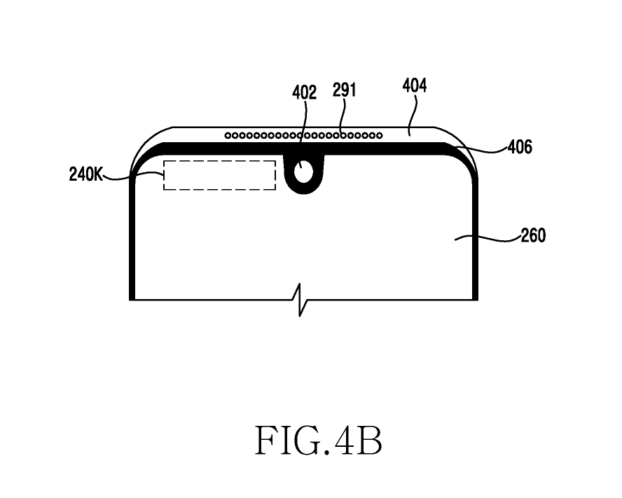

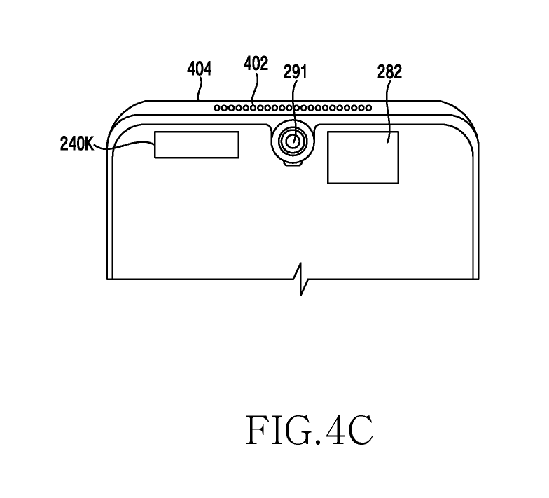

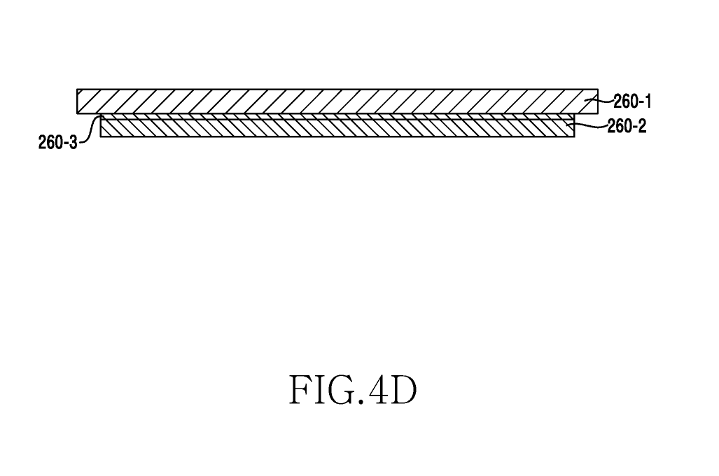

FIGS. 4A, 4B, 4C and 4D are diagrams illustrating an example illuminance sensor disposed in an electronic device according to various example embodiments of the present disclosure. FIGS. 4A, 4B, 4C and 4D depict the arrangement of a display 260, a camera module 291, and an illuminance sensor 240K in an electronic device 101.

Referring to FIG. 4A, the electronic device 101 includes the display 260, the camera module 291, and the illuminance sensor 240K. The display 260 is disposed in one side of the electronic device 101, and the camera module 291 is disposed in the same side as the display 260. A lens of the camera module 291 is exposed to outside. The illuminance sensor 240K is disposed inside the electronic device 101, and on the back side of, that is, under the display 260. That is, the illuminance sensor 240K is not physically exposed to the outside.

The illuminance sensor 240K can be disposed under the display 260. One side of the electronic device 101 can further include a space for the display 260 as illustrated in FIG. 4B and FIG. 4C. For example, referring to FIGS. 4B and 4C, in addition to the display 260, the one side exposing the display 260 in the electronic device 101 can further include a receiver hole 402 for a speaker 282, a housing black marker 404, and a window black marker 406. As the illuminance sensor 240K is mounted under the display 260, the window black marker 406 can be considerably reduced and the hole exposed to the outside can be decreased. That is, a region of the display 260 can relatively expand. In other words, as the illuminance sensor 240K is mounted under the display 260, the region for the window black marker 406 reduces and the region of the display 260 expands. Hence, a larger screen can be provided to the user in the electronic device of the same size.

As above, the illuminance sensor 240K is disposed on the back side of, that is, under the display 260. FIG. 4D depicts layers of the illuminance sensor 240K and the display 260. Referring to FIG. 4D, the display 260 includes a glass layer 260-1 and a display layer 260-2. Part of the display layer 260-2 can include a display active area 260-3. The illuminance sensor 240K is disposed under the display layer 260-2. The illuminance sensor 240K, which measures the illuminance outside the electronic device 101, senses the light beyond the glass layer 260-1. Accordingly, the illuminance measurement of the illuminance sensor 240K can be affected by the emission of the display 260.

Based on the structure of the electronic device 101, the electronic device 101 measures the illuminance using the illuminance sensor 240K. The illuminance sensor 240K is disposed under the display 260. According to various example embodiments, whole or part of the illuminance sensor 240K can be disposed under the display 260 as illustrated in FIG. 4A.

According to various example embodiments, the measurement of the illuminance sensor 240K is controlled according to the on/off of the display 260. In some cases, ‘on/off’ can be interpreted in various meanings. For example, on/off may be determined based on whether a corresponding component operates. Activation/deactivation or enable/disable may be used as the similar expression.

In various example embodiments, the on/off of the display 260 is determined based on whether the display 260 emits the light. The off state of the display 260 indicates that the display 260 does not emit the light. In so doing, the display 260 does not operate at all, or conduct other internal operation. Accordingly, the on state of the display 260 can for example be referred to as an emitting state, and the off state of the display 260 can for example be referred to as a non-emitting state.

In various example embodiments, the on/off of the illuminance sensor 240K is determined based on whether the light is sensed from the outside. In the following, the on state of the illuminance sensor 240K may refer, for example, to a situation in which the illuminance sensor 240K receives the light or generates a sensing value. Accordingly, the off state of the illuminance sensor 240K may refer, for example, to a situation in which the illuminance sensor 240K does not receive the light or does not generate the sensing value. In some cases, the illuminance sensor 240K in the off state can perform other operation (e.g., Analog to Digital Converter (ADC) operation) or illuminance calculation using the sensing value.

In various example embodiments to be explained, the sensing value may refer, for example, to an analog value measured by the illuminance sensor 240K or a digital value corresponding to the analog value. For example, the sensing value can be used to indicate raw data to determine the illuminance. In some cases, the sensing value can be referred to as a sensing value, a measurement value, raw data, and so on. The illuminance is information about brightness determined from at least one sensing value. Lux can be used as the unit of the illuminance.

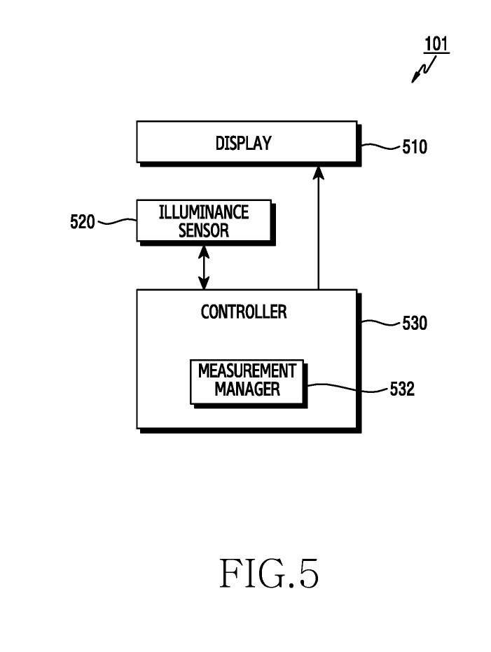

FIG. 5 is a block diagram illustrating an example electronic device according to various example embodiments of the present disclosure. The term such as a unit or the like may refer, for example, to a unit for processing at least one function or operation, and this can be implemented by hardware, software, or a combination thereof.

Referring to FIG. 5, the electronic device 101 includes a display 510, an illuminance sensor 520, and a controller (e.g. including processing circuitry and/or program elements) 530.

The display 510 is a device for displaying a screen of the electronic device 101. For example, the display 510 can include at least one of an OLED, a Quantum-dot LED (QLED), and an LED, or the like, but is not limited thereto. The display 510 corresponds to the display 160 of FIG. 1 and the display 260 of FIG. 2.

The illuminance sensor 520 is a hardware component for measuring the illuminance, that is, the brightness. The illuminance sensor 520, which is the component of the electronic device 101, measures the brightness at a place where the electronic device 101 is located. For example, the illuminance sensor 520 generates a physical signal corresponding to the brightness level. In some cases, the illuminance sensor 520 can include at least one of a configuration (e.g., ADC) for converting the physical signal to digital data and a configuration for calculating the illuminance from the measurement value. The illuminance sensor 520 can include any sensor which uses intensity of light, such as a spectrometer or a UV sensor. The illuminance sensor 520 can include at least one component (e.g., a photo diode) for receiving the light. The illuminance sensor 520 corresponds to the illuminance sensor 240K of FIG. 2.

In various example embodiments, the illuminance sensor 520 can measure the illuminance in various fashions. For example, the illuminance sensor 520 can measure the illuminance based on measurement values of an R channel, a G channel, a B channel, and a clear (C) channel. The present disclosure does not exclude an illuminance sensor which operates in a different manner. Using the illuminance sensor operating in the different manner, the electronic device 101 can fulfill operations according to various embodiments to be explained. For example, the illuminance sensor 520 can be an Ambient Light Sensor (ALS) using IR and visible light. In some cases, the illuminance sensor 520 can be referred to as a brightness sensor, an illuminance measurer, an illuminance sensor module, an illuminance sensor sensing module, and so forth.

In various example embodiments, the illuminance sensor 520 is disposed on the back side of the display 510. Accordingly, the illuminance sensor 520 can be affected by characteristics of an element of the display 510. For example, when the display 510 includes an LCD, its backlight can degrade transmittance of the illuminance sensor 520. For example, when the display 510 includes an OLED or a QLED, characteristics of the OLED and the QLED which emits the light per pixel can affect the illuminance sensor 520.

The controller 530 may include various processing circuitry and/or program elements and controls the operations of the electronic device 101. For example, the controller 530 can control the screen displaying of the display 510 and the measurement of the illuminance sensor 520. In particular, the controller 530 includes a measurement manager 532 for controlling the illuminance sensor 520 based on the on/off state of the display 510. For example, the controller 530 controls various functions associated with the illuminance measurement to be explained. The controller 530 can include the processor 120 of FIG. 1 or the processor 210 of FIG. 2.

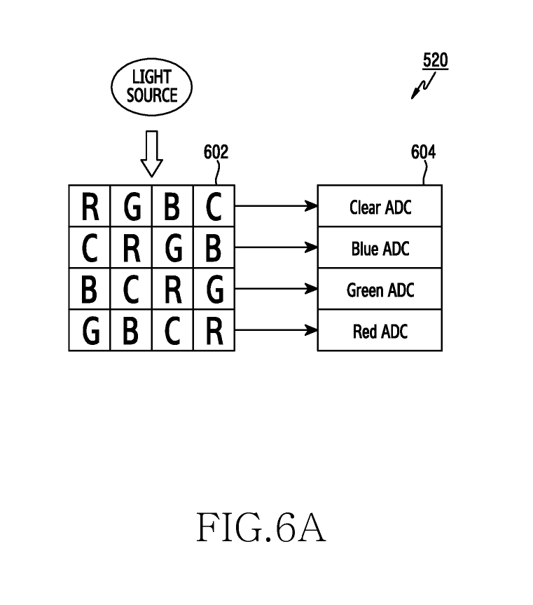

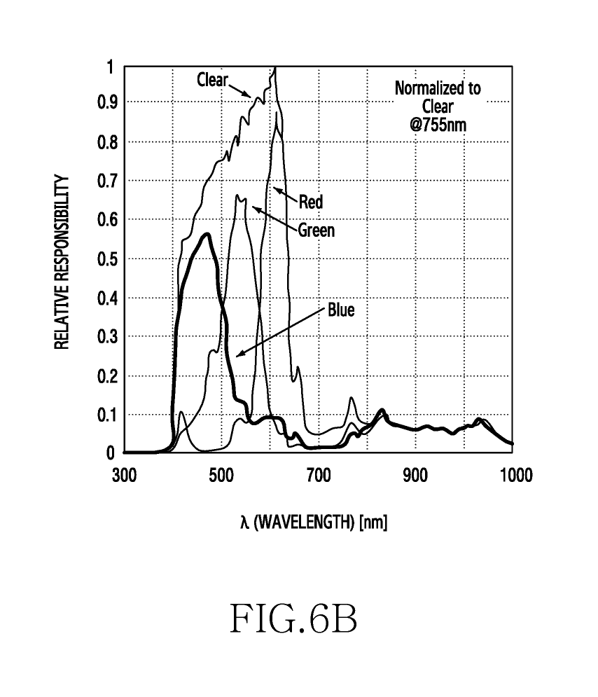

FIGS. 6A and 6B are diagrams illustrating example structure and measurement results of an illuminance sensor of an electronic device according to various example embodiments of the present disclosure, where the illuminance sensor 520 uses the RGB channel.

Referring to FIG. 6A, the illuminance sensor 520 may include a light receiver 602 and a converter (e.g., including converter circuitry) 604. The light receiver 602 includes a plurality of measuring elements for measuring the light of the R channel, the G channel, the B channel, and the C channel. Each measuring element can include, for example, a photo diode. The light receiver 602 generates analog raw data associated with the illuminance. The light receiver 602 can be referred to as a pixel unit, a measurer, and so forth. The converter 604 may include various converting circuitry, such as, for example, and without limitation, an analog to digital converter circuit, and converts the analog values generated by the light receiver 602, to digital values. The converter 604 can be referred to as an ADC or an ADC set. The measuring elements of the light receiver 602 obtain an R value, a G value, a B value, and a C value, and calculate the illuminance. For doing so, the illuminance sensor 520 can further include a calculator (not shown) for calculating the illuminance using the output of the converter 604. For example, the calculator can identify a type of the light source (e.g., halogen, incandescent light, fluorescent light, natural light) based on a ratio of the R value, the G value, the B value, and the C value, and determine the illuminance based on the type of the light source.

FIG. 6B is a diagram illustrating example measurement values of the R channel, the G channel, the B channel, and the C channel in graphical form. The B channel covers the light in 450 nm, the G channel covers the light in 550 nm, the R channel covers the light in 550 nm, and the C channel covers the whole visible ray area. Upon obtaining the sensing values of the channels as illustrated in FIG. 6A, the illuminance is determined based on the sensing values.

Various example embodiments of the present disclosure are described with flowcharts, timing examples, and measurement examples. In the following, the electronic device can include the electronic device 101 of FIG. 1, the whole or part (e.g., the processor 120) of the electronic device 201 of FIG. 2, or the whole or part (e.g., the controller 530) of the electronic device 101 of FIG. 5.

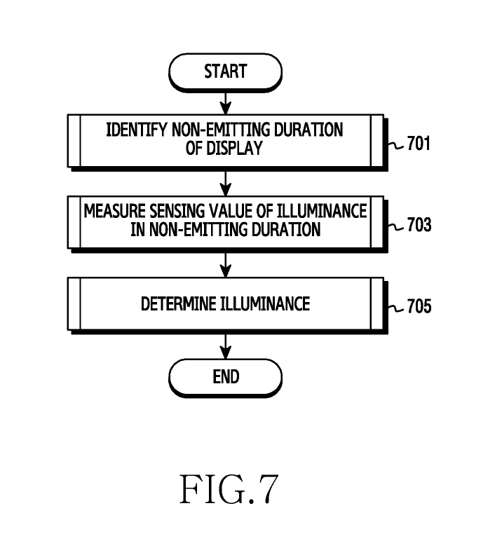

FIG. 7 is a flowchart illustrating an example method for measuring illuminance in an electronic device according to various example embodiments of the present disclosure. FIG. 7 illustrates an example operating method of the electronic device 101.

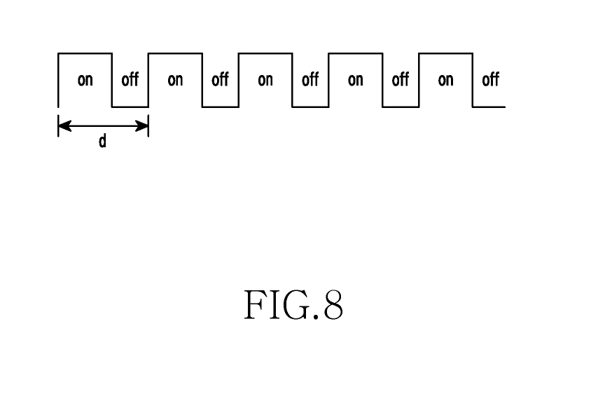

Referring to FIG. 7, in operation 701, the electronic device identifies a non-emitting duration of the display 510. For example, the controller 530 identifies at least one of a ratio of the emitting duration and the non-emitting duration of the display 510, and a start point of the non-emitting duration. For example, the emitting duration and the non-emitting duration of the display 510 can be distributed as illustrated in FIG. 8.

In FIG. 8, the emitting duration of the display 510 is ‘on’ and the non-emitting duration is ‘off’. The display 510 periodically repeats the emitting duration and the non-emitting duration according to an operating frequency (e.g., 60 Hz).

Referring to FIG. 8, the emitting duration and the non-emitting duration iterate at a regular cycle. The emitting duration can be the same as or shorter than the non-emitting duration in length. Further, the ratio of the emitting duration and the non-emitting duration can dynamically change based on the control of the display 510. For example, the ratio of the emitting duration and the non-emitting duration can be adjusted according to a required luminance.

In operation 703, the electronic device measures a sensing value of the illuminance in the non-emitting duration. That is, the controller 530 controls the illuminance sensor 520 to generate at least one sensing value in the non-emitting duration. That is, in the non-emitting duration, the controller 530 activates the measurement of the illuminance sensor 520. Hence, at least one sensing value can be obtained with less influence from the display 510.

In operation 705, the electronic device determines the illuminance. That is, the controller 530 calculates (determines) the illuminance from the at least one sensing value. For doing so, the controller 530 can identify a type of a light source based on the at least one sensing value, identify an illuminance calculation rule based on the type of the light source, and then determine the illuminance according to the rule. More specifically, the controller 530 can measure an amount of the light of each wavelength range in the R channel, the G channel, the B channel, and the C channel, remove an IR component from the visible light using the C channel value, identify the type of the light source based on the ratio of the channel values, and calculate the illuminance value through modeling with the light source.

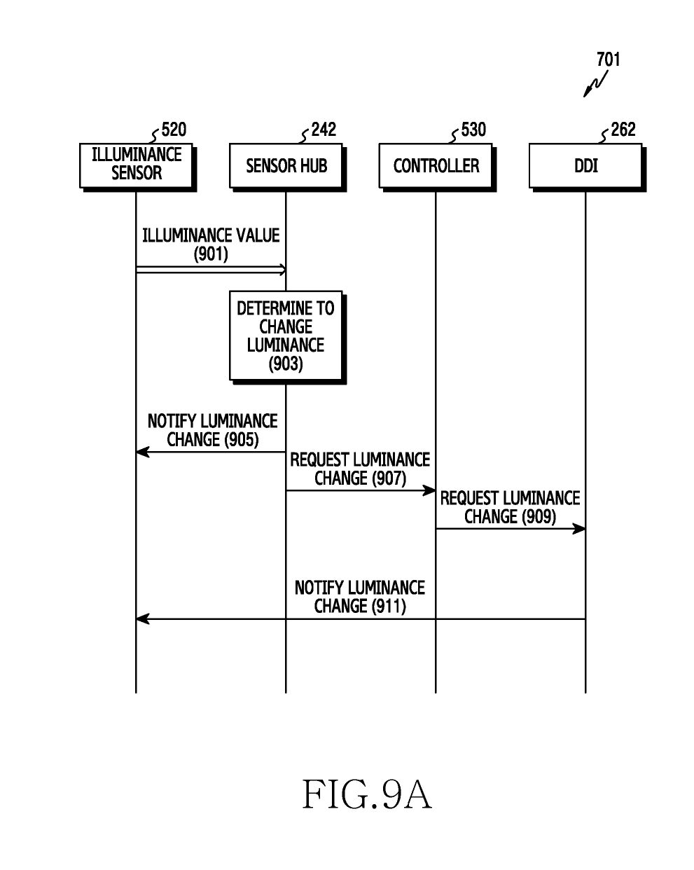

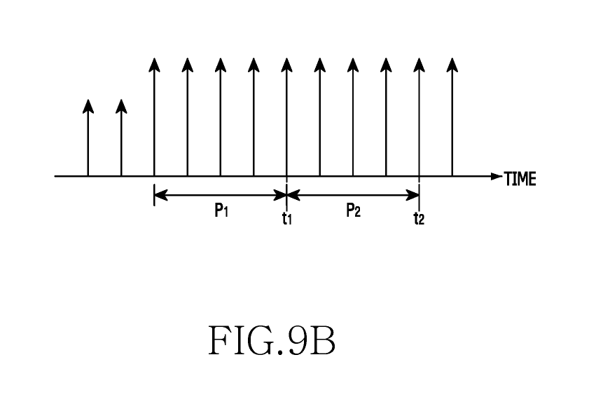

As illustrated in FIG. 7 and FIG. 8, the illuminance can be measured. Using the non-emitting duration of the display 510, the influence of the emission of the display 510 can be reduced. According to an embodiment, the brightness, that is, the luminance of the display 510 can change depending on ambient illuminance. Herein, the luminance changes by adjusting the ratio of the emitting duration and the non-emitting duration of the display 510. Thus, to utilize the non-emitting duration, the illuminance sensor 520 needs to synchronize with the ratio change of the on duration and the off duration of the display 510. The synchronization is illustrated in FIG. 9A and FIG. 9B.

FIGS. 9A and 9B are diagrams illustrating example signal exchange and control timing for synchronization in response to emission cycle change of a display in an electronic device according to various example embodiments of the present disclosure. FIG. 9A depicts the signal exchange between internal components of the electronic device 101.

Referring to FIG. 9A, in operation 901, the illuminance sensor 520 provides the illuminance value to the sensor hub 242. The illuminance sensor 520 periodically provides the illuminance to the sensor hub 242, which is repeated in subsequent operations. For example, the illuminance is provided at time intervals as illustrated in FIG. 9B. For example, the time interval can be 200 ms.

In operation 903, the sensor hub 242 determines that it is necessary to change the luminance. The luminance change is determined based on the illuminance fed from the illuminance sensor 520. That is, the luminance is defined to correspond to a certain range of the illuminance. In other words, the luminance can change based on the change of the illuminance range. Herein, the change of the illuminance range means that the illuminance crosses a reference value, that is, the illuminance which is to be lower than the reference value exceeds the reference value or the illuminance which is to be higher than the reference value falls below the reference value. Thus, when the illuminance crosses the reference value, the sensor hub 242 determines that it is necessary to change the luminance. At this time, when the illuminance crossing the reference value is maintained for a predefined time, the sensor hub 242 can determine to change the luminance. For example, when the illuminance rises and then stays for a time P₁ as shown in FIG. 9B, the change of the luminance can be determined at a time point t₁. For example, the time P₁ can be 1 s.

In operation 905, the sensor hub 242 notifies the luminance change to the illuminance sensor 520. That is, the sensor hub 242 sends a signal notifying the luminance change to the illuminance sensor 520. The luminance change can change after a predefined time passes from the notification. For example, the luminance can change at a time point t₂ after a time P₂ passes from the time point t₁ as shown in FIG. 9B. For example, the time P₂ can be 1 s.

In operation 907, the sensor hub 242 requests the luminance change from the controller 530. That is, the sensor hub 242 sends a signal requesting the luminance change of the display 510, to the controller 530. The sensor hub 242 and the controller 530 can communicate with each other through a Serial to Parallel Interface (SPI).

In operation 909, the controller 530 requests the luminance change from the DDI 262. That is, the controller 530 sends a signal requesting the luminance change of the display 510, to the DDI 262. The controller 530 and the DDI 262 can communicate with each other using Mobile Industry Processor Interface (MIPI).

In operation 911, the DDI 262 notifies the luminance change to the illuminance sensor 520. That is, the DDI 262 sends an interrupt signal notifying the luminance change of the display 510, to the illuminance sensor 520. Although not depicted in FIG. 9, the DDI 262 further sends a control signal for the luminance change to the display 510. According to the interrupt signal, the illuminance sensor 520 can update information (e.g., a register value) indicating the ratio of the emitting duration and the non-emitting duration of the display 510.

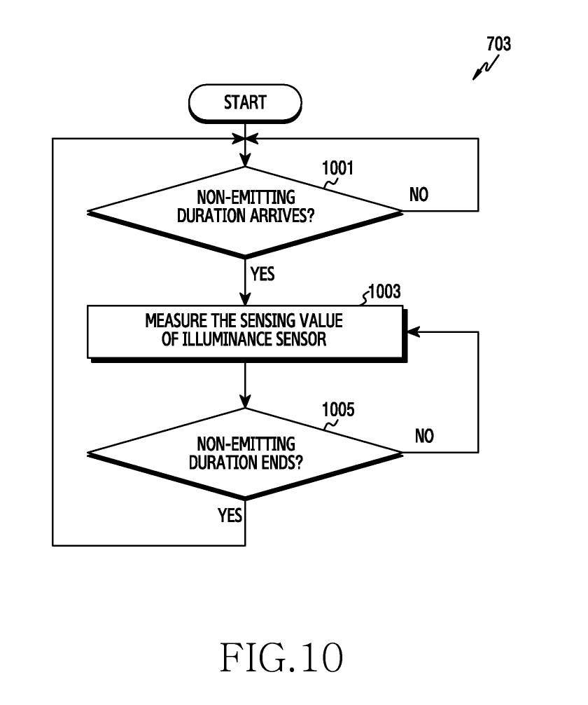

In FIG. 9A and FIG. 9B, although the ratio of the emitting duration and the non-emitting duration changes, the illuminance measurement using the non-emitting duration can be conducted. The illuminance measurement using the non-emitting duration can be carried out in various manners. Various example embodiments for the sensing value measurement are described below with reference to FIGS. 10 through 15.

FIG. 10 is a flowchart illustrating an example method for measuring a sensing value in an electronic device according to various example embodiments of the present disclosure. FIG. 10 illustrates an operating method of the electronic device 101.

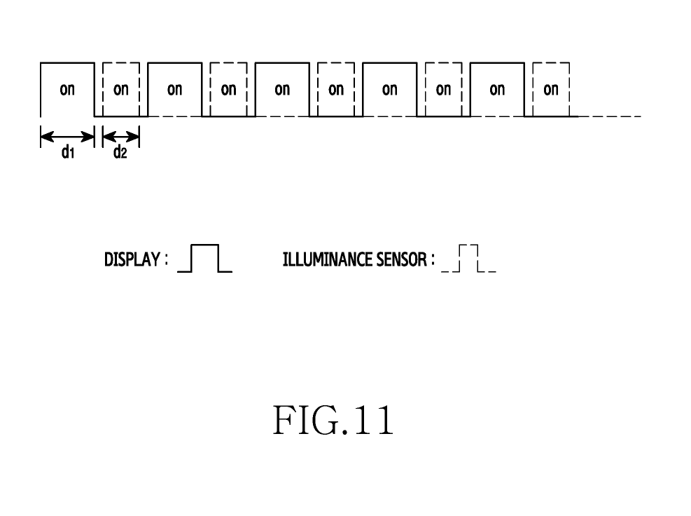

Referring to FIG. 10, in operation 1001, the electronic device determines whether the non-emitting duration arrives. That is, the controller 530 monitors the state of the display 510 and determines whether the non-emitting duration starts. Referring to FIG. 11, the display 510 operates in the emitting state for a duration of a length d₁ and operates in the non-emitting state in other duration. The controller 530 or the illuminance sensor 520 can determine whether the non-emitting duration arrives based on information about the ratio of the emitting duration and the non-emitting duration of the display 510.

When the non-emitting duration arrives, the electronic device measures the sensing value in operation 1003. That is, the controller 530 controls the illuminance sensor 520 to obtain the sensing value according to a sampling period. In operation 1005, the electronic device determines whether the non-emitting duration ends. When the non-emitting duration does not end, the electronic device repeats operation 1003. That is, the controller 530 generates at least one sensing value to determine the illuminance through the illuminance sensor 520 over the non-emitting duration. For example, as illustrated in FIG. 11, the electronic device can measure at least one sensing value for a duration of the length d₂ which is shorter than or equal to the length of the non-emitting duration.

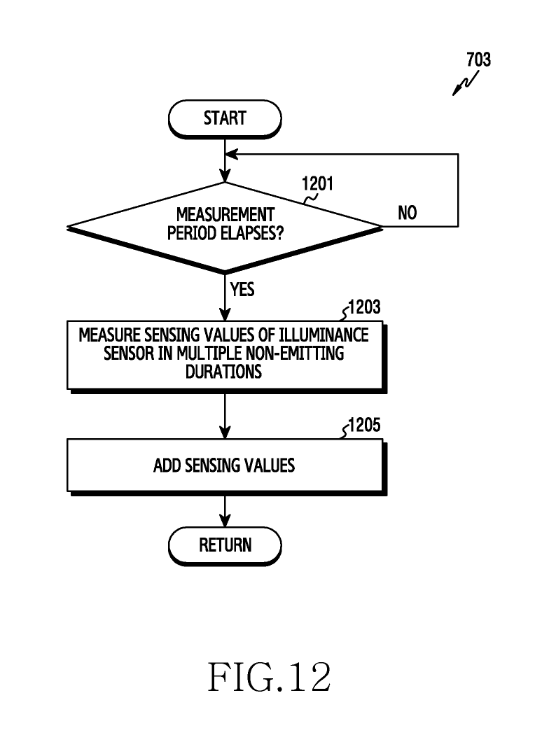

FIG. 12 is a flowchart illustrating an example method for measuring a sensing value in an electronic device according to various example embodiments of the present disclosure. FIG. 12 illustrates an operating method of the electronic device 101 when a plurality of non-emitting durations is integrated.

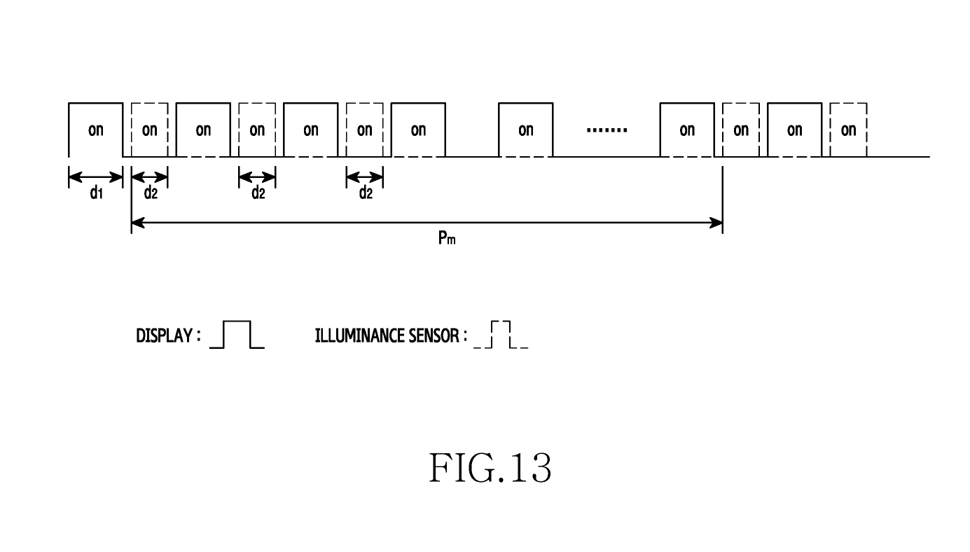

Referring to FIG. 12, in operation 1201, the electronic device determines whether a measurement period elapses. That is, the illuminance is measured over a certain period. Herein, the certain period can be referred to as a sampling period. For example, the illuminance can be measured at time intervals of Pₘ, that is, at the period of Pₘ as illustrated in FIG. 13. Hence, the controller 530 can determine whether one measurement period elapses after previous measurement. In other words, the controller 530 determines whether a next measurement time arrives.

When the measurement period passes, the electronic device measures sensing values over a plurality of non-emitting durations in operation 1203. That is, to obtain the measurement duration for determining at least one illuminance value, the controller 530 generate sensing values over the non-emitting durations. For example, the controller 530 controls the illuminance sensor 520 to measure the sensing values over three non-emitting durations as shown in FIG. 13. In this case, the three durations of the time length d₂ are included and accordingly the measurement duration of the length 3d₂ can be obtained.

In operation 1205, the electronic device determines a total sensing values. That is, the controller 530 integrates sensing values by adding each sensing value acquired over the measurement period of the length 3d₂ . According to another embodiment, illuminance values determined from the sensing values per non-emitting duration can be integrated. In this case, the controller 530 can determine a plurality of illuminance values from the sensing values per non-emitting duration and integrate the determined illuminance values.

In FIG. 12, the three non-emitting durations are used for one measurement. However, as the emitting duration of the display 510 increases, the non-emitting duration decreases and accordingly the number of the non-emitting durations for one measurement can increase over four durations. For example, the length of the emitting duration can increase to raise the luminance of the display 510.

In FIG. 12, since the measurement duration required for the illuminance measurement is longer than non-emitting duration, the multiple non-emitting durations are used. However, when a condition of including the emitting duration into the measurement duration is satisfied, a continuous measurement duration including the emitting duration can be provided. For example, when a screen of the display 510 is in a color (e.g., black) which affects the illuminance measurement below a threshold, the electronic device does not limit the measurement duration to the plurality of the separate non-emitting durations and can use the continuous duration including up to the emitting duration for the measurement.

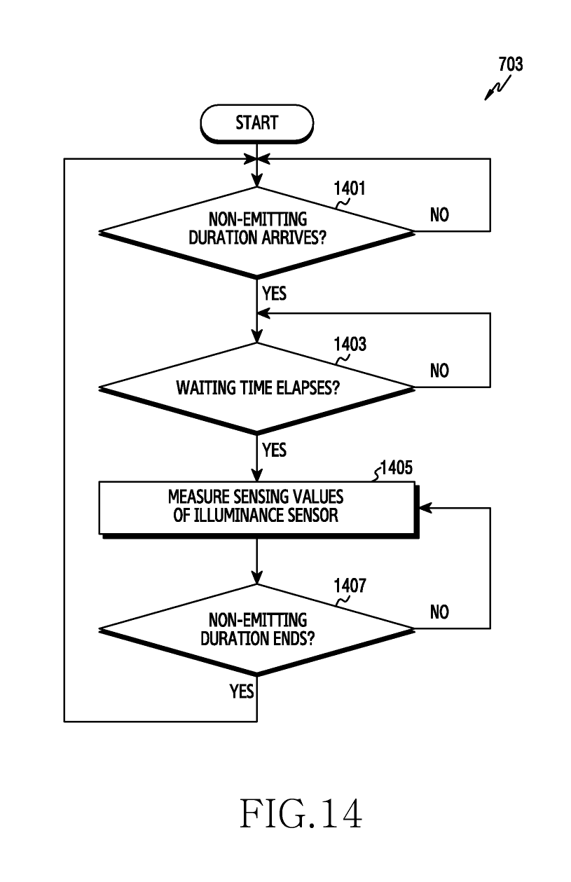

FIG. 14 is a flowchart illustrating an example method for measuring a sensing value in an electronic device according to various example embodiments of the present disclosure. FIG. 14 illustrates an operating method of the electronic device 101 in consideration of (e.g., taking into account) afterimage of the display 510.

Referring to FIG. 14, in operation 1401, the electronic device determines whether the non-emitting duration arrives. That is, the controller 530 monitors the state of the display 510 and determines whether the non-emitting duration arrives. The display 510 operates in the emitting state for a duration of a length d₁ and operates in the non-emitting state for other durations. The controller 530 or the illuminance sensor 520 can determine based on ratio information of the emitting duration and the non-emitting duration of the display 510 whether the non-emitting duration arrives.

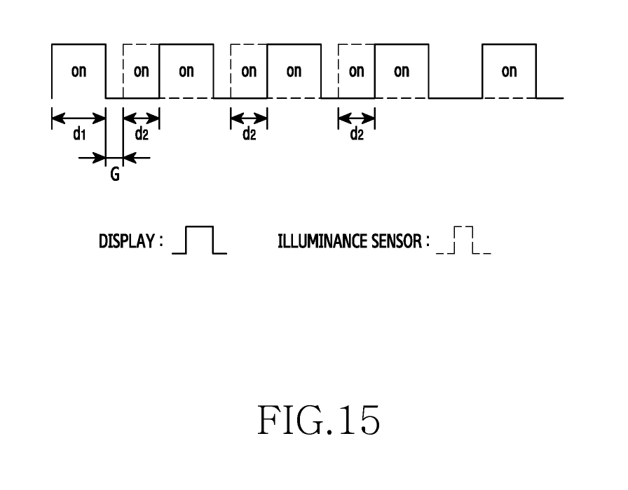

When the non-emitting duration comes, the electronic device determines whether a waiting time elapses in operation 1403. The waiting time is defined by considering the time of the afterimage immediately after the non-emitting duration of the display 510. When the waiting time does not pass, the electronic device returns to operation 1403. That is, the controller 530 waits for the measurement until the waiting time elapses. For example, the controller 530 waits for the measurement over a duration of a length G as illustrated in FIG. 15. Hence, the measurement duration can be configured just before a next emitting duration. Herein, the waiting time can be determined variously according to the element type of the display 510.

When the waiting time passes, the electronic device measures a sensing value in operation 1405. That is, the controller 530 controls the illuminance sensor 520 to acquire the sensing value. In operation 1407, the electronic device determines whether the non-emitting duration ends. When the non-emitting duration does not end, the electronic device returns to operation 1405. That is, the controller 530 generates at least one sensing value to determine the illuminance through the illuminance sensor 520 over the non-emitting duration. For example, the controller 530 can measure at least one sensing value for the duration of the length d₂ which is shorter than the length of the non-emitting duration as shown in FIG. 14.

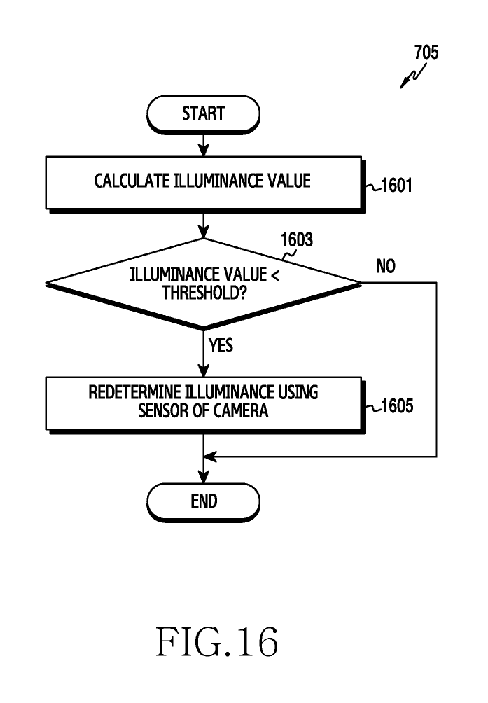

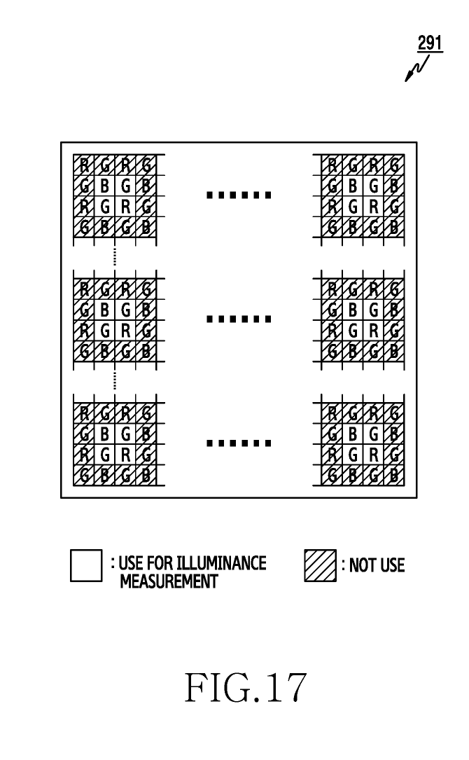

In FIG. 10 through FIG. 15, the illuminance can be determined based on the sensing values acquired in the non-emitting duration. The non-emitting duration is adopted to mitigate the influence from the emission of the display. For higher illuminance, the influence from the emission of the display reduces. Conversely, for lower illuminance, the influence from the emission of the display can increase. Thus, when the illuminance is measured below a certain level, reliability of the illuminance measurement result is relatively low. In this case, for more accurate illuminance measurement under the low illuminance, the electronic device can compensate for the illuminance based on an RGB value ratio, that is, a Color On Pixel Ratio (COPR) of each pixel of the display 510. However, when the illuminance is too low, the accuracy of the illuminance can greatly decline despite the compensation based on the COPR. Hence, a different illuminance measurement method can be employed together according to the illuminance value measured by the illuminance sensor. Now, an embodiment for determining the illuminance in consideration of current illuminance is explained below with reference to FIG. 16 and FIG. 17.

FIG. 16 is a flowchart illustrating an example method for determining illuminance based on a sensing value in an electronic device according to various example embodiments of the present disclosure. FIG. 16 illustrates an operating method of the electronic device 101.

Referring to FIG. 16, in operation 1601, the electronic device calculates an illuminance value. That is, the controller 530 calculates the illuminance from at least one sensing value. For doing so, the controller 530 can identify a light source type based on the at least one sensing value, identify an illuminance calculation rule based on the light source type, and determine the illuminance according to the rule.

In operation 1603, the electronic device determines whether the illuminance is less than a threshold. Herein, the threshold can be determined based on the influence of the emission of the display 510. For example, the threshold can be set to 500 lux. When the illuminance value is greater than or equal to the threshold, the electronic device terminates its operation. That is, the illuminance calculated in operation 1601 is determined as final illuminance.

When the illuminance is less than the threshold, the electronic device redetermines the illuminance using the sensor of the camera module 291 in operation 1605. Since the camera module 291 includes an RGB sensor for the image capturing, the illuminance can be determined using the RGB sensor. In so doing, the controller 530 can use all of measurement elements of the RGB sensor of the camera for the sake of the illuminance measurement. Alternatively, according to another embodiment, the controller 530 can use some of the measurement elements of the RGB sensor of the camera for the illuminance measurement. For example, some of the measurement elements of the sensor of the camera module 291 can be used for the illuminance measurement as shown in FIG. 17.

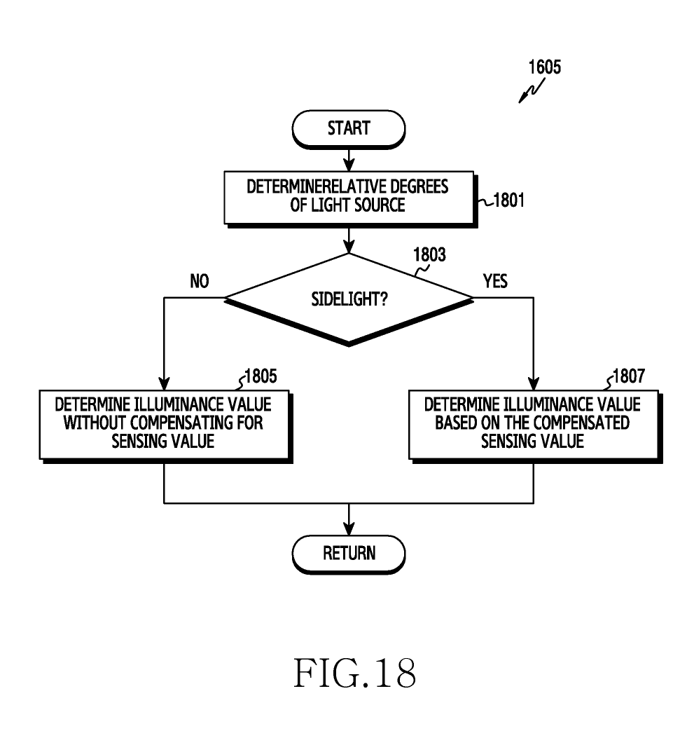

As illustrated in FIG. 16 and FIG. 17, more accurate illuminance can be measured through the camera module 291 under the low illuminance. Since the camera module 291 is exposed, it is relatively less affected by the display 510. Further, power consumption can be reduced by using only some measurement elements, rather than using all of the measurement elements. When the sensor of the camera is used, the illuminance measured can vary according to relative degrees of the light source. Hence, the illuminance determination in consideration of the relative degrees of the light source is now described by referring to FIG. 18 through 20B.

FIG. 18 is a flowchart illustrating an example method for compensating for a sensing value in photometry in an electronic device according to various example embodiments of the present disclosure. FIG. 18 illustrates an operating method of the electronic device 101.

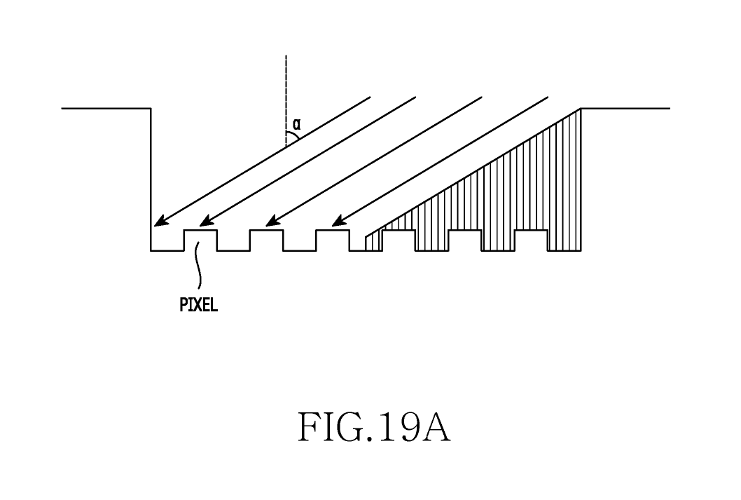

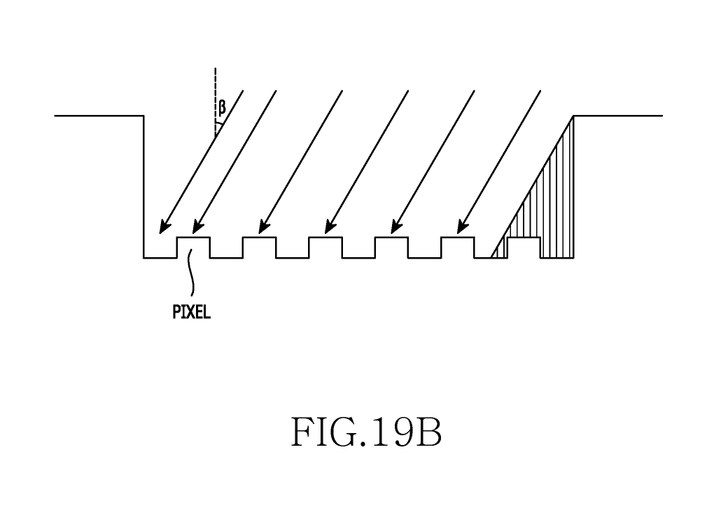

Referring to FIG. 18, in operation 1801, the electronic device determines relative degrees of the light source. The relative degrees of the light source can be determined by comparing relatively levels of the values measured by the measurement elements of the sensor. When the light comes from a side, the amount of the light provided to each measurement element, that is, to the photo diode can vary per measurement element. For example, when the light source is placed in front of the sensor, the values measured by all of the measurement elements can be the same or similar. However, when the light source is not placed in front of the sensor, the light is blocked by an obstacle near the sensor and does not directly reach some measurement elements as illustrated in FIG. 19A or FIG. 19B. Depending on the relative degrees from the light source of the sensor, the number of the measurement elements not directly reached by the light varies. That is, degrees α of FIG. 19A are greater than degrees β of FIG. 19B, and accordingly more measurement elements are not directly reached by the light in FIG. 19B. Thus, the controller 530 estimates the relative degrees based on the distribution of the activated measurement elements. More specifically, the controller 530 can identify the measurement elements which the light does not directly reach based on the sensing value per measurement element, and estimate the relative degrees for the light source based on the number of the measurement elements which the light does not directly reach.

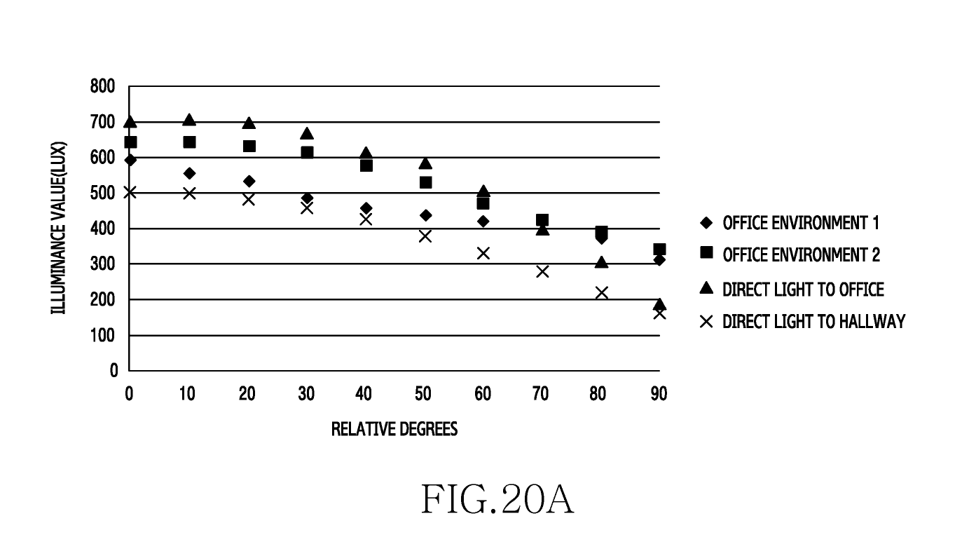

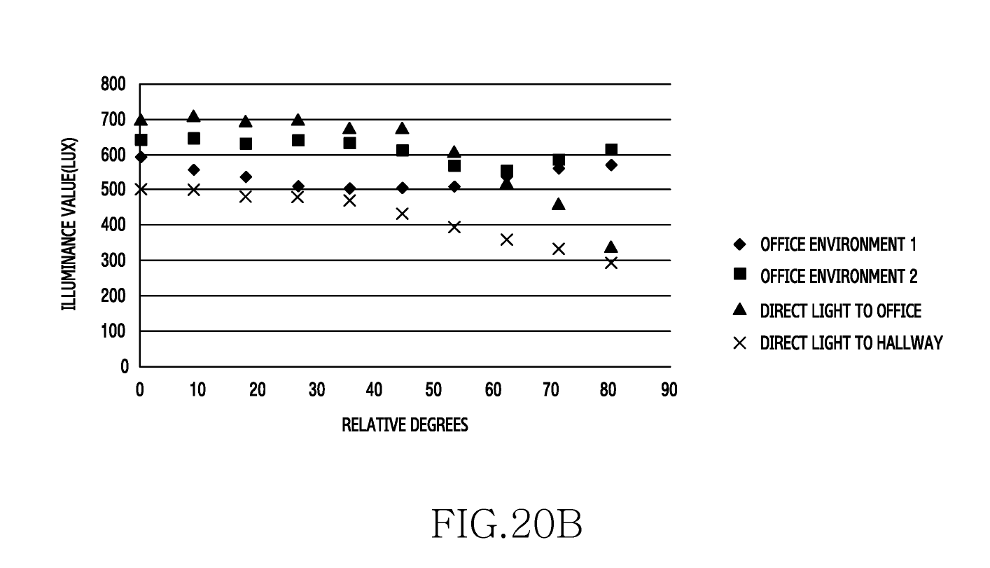

In operation 1803, the electronic device determines the light from the light source is sidelight. That is, the controller 530 determines whether the relative degrees of the light source indicate the sidelight. Herein, a degree range determined as the sidelight can vary according to various embodiments. For example, referring to FIG. 20A, the illuminance value of 10° is similar to the illuminance value of 0° in front of the light source, compared to other degrees. Accordingly, 10° can be defined as a threshold for determining the sidelight. Notably, since the influence of the sidelight differs according to an environment such as office or hallway, the environment can be further taken into account. In this case, the controller 530 can identify the threshold corresponding to the environment, compare the relative degrees estimated in operation 1801 with the threshold, and thus determine the sidelight.

When the light from the light source is not the sidelight, the electronic device determines the illuminance without compensating the sensing value in operation 1805. That is, the controller 530 determines the illuminance using the measured sensing values. For example, the controller 530 can identify the light source type based on the measured sensing values, identify an illuminance calculation rule based on the light source type, and determine the illuminance according to the identified rule.

When the light from the light source is the sidelight, the electronic device determines the illuminance based on the compensated sensing value in operation 1807. That is, the controller 530 compensates for the measured sensing values and determines the illuminance using the compensated measurement values. For example, the controller 530 can apply a weight to the sensing values of the measurement elements which the light does not directly reach. Thus, the compensation can greatly reduce illuminance differences according to the degrees as illustrated in FIG. 20B.

Referring back to FIG. 18, the electronic device compensates for the sensing values. According to another example embodiment, the electronic device can compensate for the illuminance, rather than the sensing value. Namely, the illuminance determined based on the sensing values can be compensated, rather than the sensing values. In this case, the electronic device can determine the illuminance based on the measured sensing values and compensate for the determined illuminance. For example, the electronic device can compensate for the measured illuminance value with a difference between the illuminance corresponding to the front side and the illuminance corresponding to the estimated relative degrees. Alternatively, the electronic device can compensate for the measured illuminance value by multiplying the measured illuminance value by a coefficient corresponding to the estimated relative degrees.

In FIG. 18, the illuminance can be determined with the less influence of the relative degrees with respect to the light source. That is, in the photometric measurement based on the amount of the light vertically fed, the measured illuminance is compensated and thus the intensity of the light can be calculated even at the low light level. Further, the luminance of the display varies less according to the degrees.

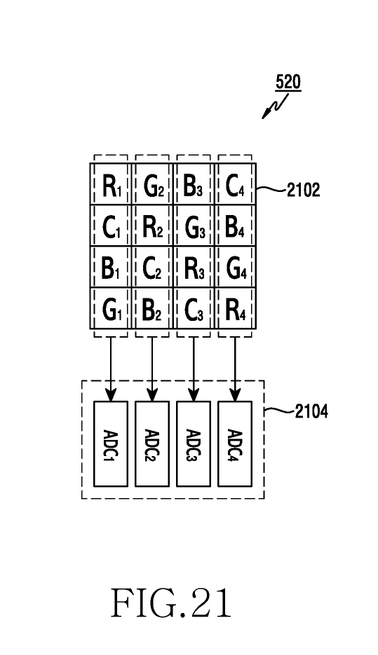

For doing so, the relative degrees need to be estimated. To estimate the relative degrees, it is necessary to determine the measurement elements which the light does not directly reach. To identify the measurement elements which the light does not directly reach, a sensor structure for obtaining the sensing value per measurement element is demanded. Alternatively, a sensor structure for obtaining the sensing value per row or column of the measurement elements is demanded. Hence, to compensate for the illuminance value measured by the illuminance sensor 520, the illuminance sensor 520 can be arranged as illustrated in FIG. 21.

FIG. 21 is a diagram illustrating an example structure of the illuminance sensor 520 in an electronic device according to various example embodiments of the present disclosure. Referring to FIG. 21, the illuminance sensor 520 includes a light receiver 2102 including a plurality of measurement elements, and a converter 2104 including a plurality of ADCs. Unlike FIG. 6, each ADC of the converter 2104 is connected to process analog values from the measurement elements of a particular row or column, rather than analog values from the measurement elements of the same channel. By comparing output values of the ADCs, how many row or columns are concealed can be determined.

In the above-stated embodiments, the electronic device acquires the sensing value in the non-emitting duration of the display 510. However, although the display 510 is emitting the light, when the screen color or brightness of the region of the illuminance sensor 520 satisfies a certain condition, the influence on the illuminance sensor 520 can be ignored. Thus, the measurement of the illuminance sensor 520 can be controlled according to the screen color of the display 510.

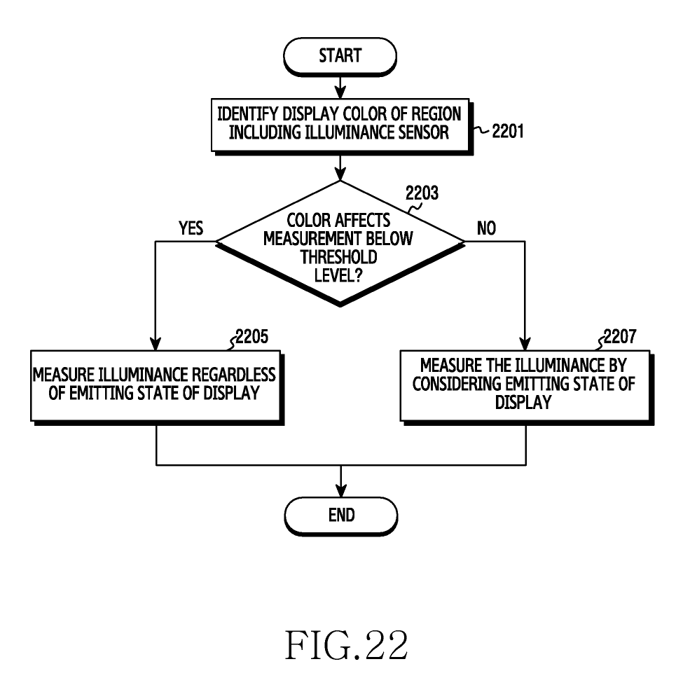

FIG. 22 is a flowchart illustrating an example method for measuring illuminance by considering a display color in an electronic device according to various example embodiments of the present disclosure. FIG. 22 illustrates an operating method of the electronic device 101.

Referring to FIG. 22, in operation 2201, the electronic device identifies the screen color of the display of the region including the illuminance sensor. For example, the controller 530 can identify the color by identifying values of the measurement elements corresponding to the region including the illuminance sensor on a displayed image.

In operation 2203, the electronic device determines whether the identified color affects the measurement below a threshold level. That is, the controller 530 determines whether or not to ignore the influence from the identified color in the emission. The color affecting below the threshold level can be defined variously according to a specific embodiment. For example, the color affecting below the threshold level can be defined as black.

When the identified color affects the measurement below the threshold level, the electronic device measures the illuminance regardless of the emitting state of the display 510 in operation 2205. That is, the controller 530 controls the illuminance sensor 520 to acquire sensing values in the non-emitting duration and the emitting duration of the display 510. Namely, although the display 510 emits the light, the controller 530 regards it as the non-emitting duration.

When the identified color does not affect the measurement below the threshold level, the electronic device measures the illuminance by considering the emitting state of the display 510 in operation 2207. That is, the controller 530 controls the illuminance sensor 520 to acquire sensing values in the non-emitting duration of the display 510. For example, the controller 530 can generate the sensing values as shown in FIG. 12, FIG. 14, or FIG. 16.

In FIG. 22, the sensing value can be measured in the emitting duration of the display 510 as an exceptional case of the illuminance measurement using the non-emitting duration. Hence, more illuminance measurement durations can be obtained. For doing so, the screen color of the region including the illuminance sensor is estimated. However, according to another embodiment, the color of the whole screen can be estimated. In this case, the electronic device can determine whether the color of the whole screen affects the measurement below the threshold.

As above, the illuminance measurement can be controlled based on the emission state of the display 510. When the display 510 is flexible, the emission region of the display 510 can change according to a shape of the flexible display, that is, the folding state. For example, part of the flexible display region may not be used according to the folding state, which can be regarded as a long non-emitting duration. That is, the non-emitting duration can be identified based on the folding state of the flexible display. Thus, the illuminance measurement can be controlled according to the folding state of the flexible display.

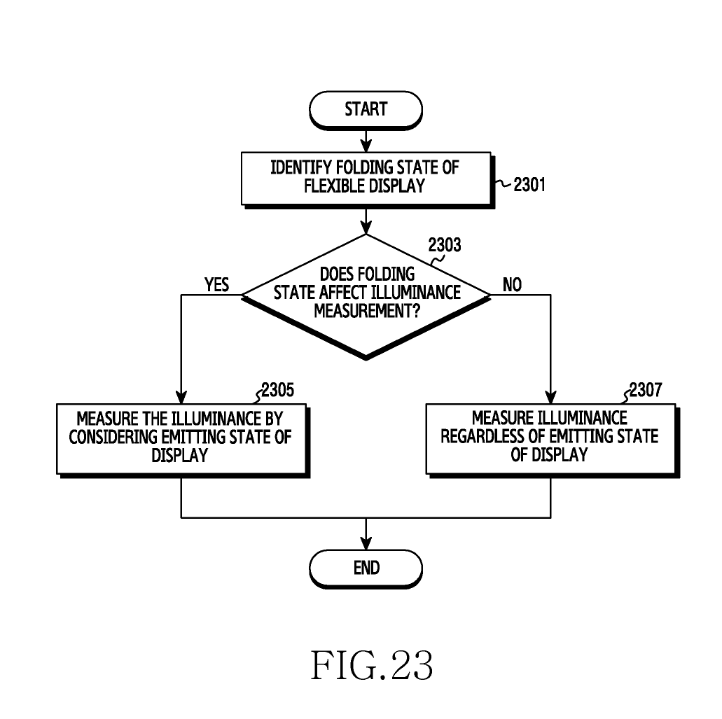

FIG. 23 is a flowchart illustrating an example method for measuring illuminance by considering a folding state of a display in an electronic device according to various example embodiments of the present disclosure. FIG. 23 illustrates an operating method of the electronic device 101.

Referring to FIG. 23, the electronic device identifies the folding state of the display 510 in operation 2301. The display 510 can change in shape when it is bent or folded by an external force, and the controller 530 can identify the folding state through a sensor.

In operation 2303, the electronic device determines whether the folding state affects the illuminance measurement. That is, the controller 530 determines whether the region including the illuminance sensor displays the screen in the folding state. That is, the controller 530 determines whether part of the display 510 including the region of the illuminance sensor is in the long non-emitting duration.

When the folding state affects the illuminance measurement, the electronic device measures the illuminance by considering the emission state of the display 510 in operation 2305. That is, the controller 530 controls the illuminance sensor 520 to acquire sensing values in the non-emitting duration of the display 510. For example, the controller 530 can generate the sensing values as shown in FIG. 12, FIG. 14, or FIG. 16.

When the folding state does not affect the illuminance measurement, the electronic device measures the illuminance regardless of the emission state of the display 510 in operation 2307. That is, since part including the region of the illuminance sensor is in the long non-emitting duration, the display 510 emits the light in the rest region. Hence, the controller 530 controls the illuminance sensor 520 to acquire the sensing values in the non-emitting duration and the emitting duration of the display 510. In other words, the controller 530 regards the emission state of the display 510 as the non-emitting duration.

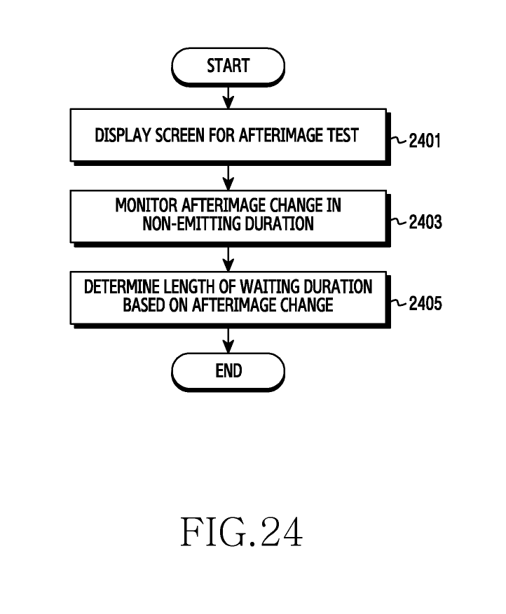

As such, the embodiment of FIG. 14 applies the waiting time considering the afterimage of the display 510. The waiting time can be predefined based on characteristics of the display 510. According to another example embodiment, the waiting time can be optimized through a test. The optimization of the waiting time is described below with reference to FIG. 24.

FIG. 24 is a flowchart illustrating an example method for determining a waiting time by considering afterimage of the display 510 in an electronic device according to various example embodiments of the present disclosure. FIG. 24 illustrates an operating method of the electronic device 101.

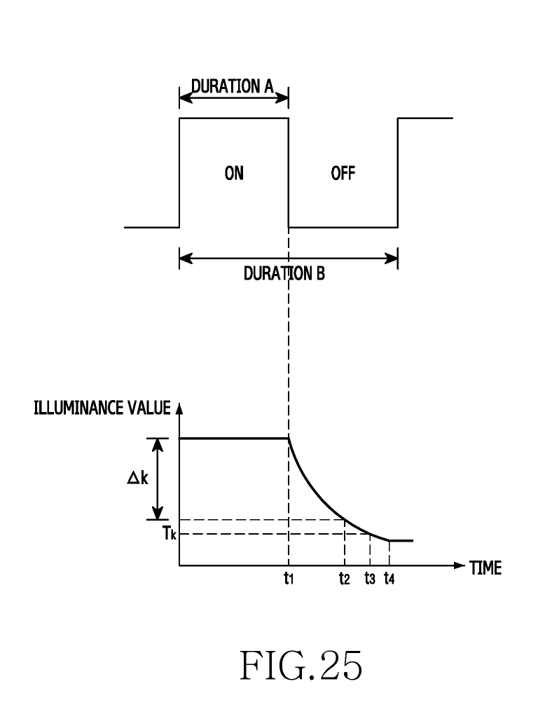

Referring to FIG. 24, the electronic device displays a screen for the afterimage test in operation 2401. For example, the controller 530 can display the screen for the afterimage test in a duration A which is one of the emitting durations of the display 510 as shown in FIG. 25. According to an example embodiment, the screen for the afterimage test can have a relatively high brightness to reduce the influence of external illuminance.

In operation 2403, the electronic device monitors an afterimage change in the non-emitting duration. That is, after the display 510 enters the non-emitting duration after the duration A, the afterimage can remain on the display 510 for a certain time. Hence, the controller 530 controls the illuminance sensor 520 to measure the illuminance in a duration B including the whole or part of the duration A and the non-emitting duration after the duration A. For example, monitoring results are shown in FIG. 25. Referring to FIG. 25, the illuminance decreases based on time, and converges when the afterimage disappears.

In operation 2405, the electronic device determines a length of the waiting time based on the afterimage change. Herein, the waiting time can be determined in various manners. For example, the controller 530 can identify a time point where the afterimage influences less than a certain level based on the change of the illuminance measured after the screen for the afterimage test is removed, and determine a time ranging from the end of the emitting duration to a time point when the afterimage influences less than the certain level, as the waiting time. Thus, the controller 530 can use the optimized waiting time.

According to an example embodiment, the waiting time can be determined based on the time point where the illuminance decreases by a certain amount. Referring to FIG. 25, the illuminance declines from the time point t₁ when the duration A ends. Since the screen for the afterimage test is predefined, the increase of the illuminance is expected based on the screen for the afterimage test. When the illuminance increases based on the screen for the afterimage test by Δk, the electronic device can determine the optimal waiting time by identifying a time point t₂ when the illuminance declines by Δk after the time t₁. That is, the electronic device can determine t₂−t₁ as the waiting time.

According to another example embodiment, the waiting time can be determined based on a time point when the illuminance reaches a particular threshold. Referring to FIG. 25, the illuminance declines from the time point t₁ when the duration A ends. Due to the afterimage, the illuminance measured after the time point t₁ is higher than the external illuminance. Next, as the afterimage gradually disappears, the illuminance approaches the external illuminance. Hence, the electronic device can determine the optimal waiting time by identifying a time point t₃ when the illuminance value measured in the duration B reaches the external illuminance Tₖ. That is, the electronic device can determine t₃−t₁ as the waiting time. For example, the electronic device can obtain the external illuminance by use of the illuminance measured in the non-emitting duration before the duration A.

According to another example embodiment, the waiting time can be determined based on the time when the illuminance converges. Referring to FIG. 25, the illuminance declines from the time point t₁ when the duration A ends. As the afterimage disappears, the influence from the display 510 vanishes. As a result, the measured illuminance can be stabilized. Namely, the illuminance can converge. Thus, the electronic device can determine the optimal waiting time by identifying a time point t₄ when the measured illuminance converges in the duration B. That is, the electronic device can determine t₄−t₁ as the waiting time.

As set forth above, the method and the electronic device according to various example embodiments can enhance the accuracy of the illuminance measurement by operating the illuminance sensor in consideration of the emitting duration of the display. Further, based on the accurate illuminance measurement, the functions controlled based on the illuminance, for example, the luminance of the display can be controlled adequately. Therefore, comfortable luminance for the ambient environment can be provided to the user.

The methods described in the claims or the present disclosure can be implemented in software, firmware, hardware, or in any combinations thereof.

The software can be stored in a computer-readable storage medium. The computer-readable storage medium stores at least one program (software module), when executed by at least one processor in an electronic device, including instructions making the electronic device to execute the method the present disclosure.

Such software can be stored in volatile or non-volatile storage devices such as a Read Only Memory (ROM), memories such as a Random Access Memory (RAM), a memory chip, a device, or an integrated circuit, or optical or magnetic readable media such as a Compact Disc (CD)-ROM, a Digital Versatile Disc (DVD), a magnetic disk, or a magnetic tape.

A storage device and a storage medium are an example of machine-readable storage media which are suitable for storing a program including instructions to implement the embodiments, or programs. The present disclosure provides a program to implement an apparatus or a method according to any one of the claims of the present disclosure, and a machine-readable storage medium including the program. Further, such programs can be transferred electronically through a medium such as a communication signal transferred through a wired or wireless connection, and may appropriately include an equivalent medium.

In the various example embodiments of the present disclosure, the elements included in the disclosure are expressed in a singular or plural form. However, the singular or plural expression is appropriately selected according to a proposed situation for the convenience of explanation and the present disclosure is not limited to a single element or a plurality of elements. The elements expressed in the plural form may be configured as a single element and the elements expressed in the singular form may be configured as a plurality of elements.

While the disclosure has been illustrated and described with reference to example embodiments thereof, it will be understood by those skilled in the art that various changes in form and details may be made therein without departing from the spirit and scope of the disclosure as defined by the appended claims and their equivalents.

What is claimed is:

1. A method of an electronic device, the method comprising:
identifying time intervals when a display of the electronic device operates in a deactivated state; and
determining illuminance using at least one sensing value measured through an illuminance sensor during the identified time intervals,
wherein the illuminance sensor is disposed under the display.

2. The method of claim 1, further comprising,
determining the illuminance using a sensing value comprising integrated the at least one sensing value measured in the time intervals when the display of the electronic device operates in the deactivated state.

3. The method of claim 1, further comprising,
identifying the at least one sensing value for determining the illuminance after a waiting time in response to a termination point of an activated state, in each of the time intervals when the display of the electronic device operates in the deactivate state.

4. The method of claim 3, wherein the waiting time is determined based on a continuous time of an afterimage of the display.

5. The method of claim 4, further comprising:
displaying a screen for determining the waiting time;
monitoring a change of the afterimage displayed on the screen during the time intervals when a display of the electronic device operates in the deactivated state; and
determining the waiting time based on one of: a time point when the measured illuminance of the time intervals decreases by a designated amount, a time point when the illuminance reaches a designated value, and a time point when the illuminance is converged.

6. The method of claim 1, further comprising:
redetermining the illuminance using a sensor of a camera when the illuminance is less than a designated value.

7. The method of claim 6, wherein the redetermining is performed using at least one measuring element included in the sensor of the camera.

8. The method of claim 1, further comprising:
determining a relative angle of a source of light based on an area of activated measuring elements; and
compensating, based on the relative angle, the at least one sensing value or the illuminance.

9. The method of claim 1, further comprising,
synchronizing the display in response to a signal indicating a change of the illuminance of the display.

10. The method of claim 1, further comprising,
generating the at least one sensing value during the time intervals during which the display operates in an activated state, when a screen color of the display affects measurement of the illuminance below a designated level.

11. An electronic device comprising:
a display for displaying a screen;
an illuminance sensor disposed under the display;
a memory storing instructions; and
at least one processor configured to execute the stored instructions to:
identify time intervals when the display of the electronic device operates in a deactivated state; and
determine illuminance using at least one sensing value measured through the illuminance sensor during the identified time intervals.

12. The electronic device of claim 11, wherein the at least one processor is further configured to execute the instructions to determine the illuminance using a sensing value comprising integrated the at least one sensing value measured in the time intervals when the display of the electronic device operates in the deactivated state.

13. The electronic device of claim 11, wherein the at least one processor is further configured to execute the instructions to identify the at least one sensing value for determining the illuminance after a waiting time in response to a termination point of an activated state, in each of the time intervals when the display of the electronic device operates in the deactivated state.

14. The electronic device of claim 13, wherein the waiting time is determined based on a continuous time of an afterimage of the display.

15. The electronic device of claim 14, wherein the at least one processor is further configured to execute the instructions to:
control to display a screen for determining the waiting time;
monitor a change of the afterimage displayed on the screen during the time intervals when the display of the electronic device operates in the deactivated state; and
determine the waiting time based on one of: a time point when the measured illuminance of the time intervals decreases by a designated amount, a time point when the illuminance reaches a designated value, and a time point when the illuminance is converged.

16. The electronic device of claim 11, wherein the at least one processor is further configured to execute the instructions to redetermine the illuminance using a sensor of a camera when the illuminance is less than a designated value.

17. The electronic device of claim 16, wherein the at least one processor is further configured to execute the instructions to redetermine using at least one measuring element of the sensor of the camera.

18. The electronic device of claim 11, wherein the at least one processor is further configured to execute the instructions to:
determine a relative angle of a light source based on an area of activated measuring elements; and
compensate for, based on the relative angle, the at least one sensing value or the illuminance.

19. The electronic device of claim 11, wherein the at least one processor is further configured to execute the instructions to synchronize with the display in response to a signal indicating a change of the illuminance of the display.

20. The electronic device of claim 11, wherein the at least one processor is further configured to execute the instructions to generate the at least one sensing value during the time intervals during which the display operates in an activated state, when a screen color of the display affects measurement of the illuminance below a designated level.
